(19) United States
(12) Patent Application Publication
(10) Pub. No.: US 2026/0036061 A1
(43) Pub. Date: Feb. 5, 2026

(54) TURBINE SHROUD ASSEMBLIES WITH AIR ACTIVATED WEDGES FOR BIASING BUFFER CAVITY SEALS

(71) Applicant: Rolls-Royce Corporation, Indianapolis, IN (US)

(72) Inventors: Grant Cook, Indianapolis, IN (US); Aaron D. Sippel, Indianapolis, IN (US); Ted J. Freeman, Indianapolis, IN (US); David J. Thomas, Indianapolis, IN (US); Clark J. Snyder, Indianapolis, IN (US); Jeffrey A. Stone, Indianapolis, IN (US)

(21) Appl. No.: 18/680,635

(22) Filed: May 31, 2024

(51) Int. Cl. F01D 11/08

(52) U.S. Cl. CPC F01D 11/08; F05D 2220/32; F05D 2230/60; F05D 2240/55

(57) ABSTRACT

A turbine shroud assembly adapted for use with a gas turbine engine includes a carrier segment, a blade track segment, and a seal system. The carrier segment arranged circumferentially at least partway around an axis. The blade track segment is coupled to the carrier segment and defines a portion of a gas path of the gas turbine engine. The seal system is arranged radially between the carrier segment and the blade track segment to block gases from flowing between the carrier segment and the blade track segment.

### FIELD OF THE DISCLOSURE

The present disclosure relates generally to turbine shroud assemblies, and more specifically to sealing of turbine shroud assemblies used with gas turbine engines.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion are exhausted out of the turbine and may provide thrust in some applications.

Compressors and turbines typically include alternating stages of static vane assemblies and rotating wheel assemblies. The rotating wheel assemblies include disks carrying blades around their outer edges. When the rotating wheel assemblies turn, tips of the blades move along blade tracks included in static shrouds that are arranged around the rotating wheel assemblies. Such static shrouds may be coupled to an engine case that surrounds the compressor, the combustor, and the turbine.

Some shrouds positioned in the turbine may be exposed to high temperatures from products of the combustion reaction in the combustor. Such shrouds sometimes include components made from materials that have different coefficients of thermal expansion. Due to the differing coefficients of thermal expansion, the components of some turbine shrouds expand at different rates when exposed to combustion products. In some examples, sealing between and coupling such components may present challenges.

### SUMMARY

The present disclosure may comprise one or more of the following features and combinations thereof.

A turbine shroud assembly adapted for use with a gas turbine engine may include a carrier segment, a blade track segment, and a seal system. The carrier segment may be arranged circumferentially at least partway around an axis. The blade track segment may be arranged circumferentially at least partway around the axis to define a portion of a gas path of the gas turbine engine. The seal system may be arranged radially between the carrier segment and the blade track segment to block gases from flowing between the carrier segment and the blade track segment.

In some embodiments, the carrier segment may include an outer wall, a first support wall that extends radially inward from the outer wall, and a second support wall that extends radially inward from the outer wall. The second support wall may extend radially inward from the outer wall at a location spaced apart axially from the first support wall to define an attachment-receiving space.

In some embodiments, the first support wall may be formed to include a radially-inwardly opening first channel and at least one buffer air passageway. The first channel may extend circumferentially relative to the axis. The at least one buffer air passageway may extend radially into the first support wall and open into the first channel to discharge buffer air radially inward away from the carrier segment.

In some embodiments, the blade track segment may include a shroud wall and an attachment feature. The shroud wall may extend circumferentially partway around the axis. The attachment feature may extend radially outward from the shroud wall into the attachment-receiving space formed in the carrier segment.

In some embodiments, the seal system may include a buffer air seal assembly arranged in the first channel between the carrier segment and the blade track segment to block gases from flowing between the carrier segment and the blade track segment. The buffer air seal assembly may include a first seal member, a second seal member spaced apart axially from the first seal member, and a sled member. The first seal member, the second seal member, and the sled member may each extend circumferentially relative to the axis. The sled member may be located radially outward of and axially between the first and second seal members.

In some embodiments, the sled member may be biased radially inward to urge the first seal member radially inward and axially forward and the second seal member radially inward and axially aft into engagement with the carrier segment and the blade track segment. The sled member may be biased radially inward to urge the first seal member radially inward and axially forward into engagement with the carrier segment and the blade track segment. The sled member may be biased radially inward to urge the second seal member radially inward and axially aft into engagement with the carrier segment and the blade track segment.

In some embodiments, the buffer air seal assembly may further include a bias member. The bias member may extend circumferentially relative to the axis. The bias member may be compressed radially between the carrier segment and the sled member to apply a bias force to the sled member to bias the sled member radially inward towards the shroud wall of the blade track segment.

In some embodiments, the bias member may be a spring. The bias member may be a spring arranged radially between the carrier segment and the sled member to apply the bias force to the sled member.

In some embodiments, the spring may have a first edge and a second edge spaced apart axially from the first edge. The first and second edges may be scalloped to allow the buffer air to flow around the spring.

In some embodiments, the bias member may be a braid seal. The braid seal may extends circumferentially about the axis.

In some embodiments, the bias member may be segmented into a first segment and a second segment. The second segment may be spaced apart circumferentially from the first segment. The at least one buffer air passageway may be located circumferentially between the first and second segments of the bias member.

In some embodiments, the bias member may be formed to include at least one through hole. The at least one through hole may extend radially therethrough. The at least one through hole may extend radially therethrough to allow the buffer air to flow through the bias member.

In some embodiments, the buffer air discharged into the first channel may bias the sled member. The buffer air discharged into the first channel may bias the sled member radially inward toward the blade track segment.

In some embodiments, the sled may have one of a semi-circle cross-sectional shape, a triangular cross-sectional shape, and a trapezoidal cross-sectional shape when viewed in a circumferential direction. In some embodiments, the sled may have a semi-circle cross-sectional shape when viewed in a circumferential direction. In some embodiments, the sled may have a triangular cross-sectional shape when viewed in a circumferential direction. In some embodiments, the sled may have one of a trapezoidal cross-sectional shape when viewed in a circumferential direction.

In some embodiments, the sled member may be formed to include at least one through hole. The at least one through hole may extend radially therethrough. The at least one through hole may extend radially therethrough to allow the buffer air to flow through the sled member.

In some embodiments, the first seal member and the second seal member may each comprise a single strand of solid metallic material. The first seal member may comprise a single strand of solid metallic material. The second seal member may comprise a single strand of solid metallic material.

In some embodiments, the first channel may be formed to define an end surface, a first side surface, and a second side surface. The end surface may extend axially. The first side surface may extend radially inward and axially forward from the end surface. The second side surface may extend radially inward and axially aft from the end surface. In some embodiments, the sled member may urge the first seal member radially inward and axially forward into the first side surface of the first channel. In some embodiments, the sled member may urge the second seal member radially inward and axially aft into the second side surface of the first channel.

In some embodiments, the second support wall may be formed to include a radially-inwardly opening second channel. The second channel may extend circumferentially relative to the axis. The turbine shroud assembly may further include another seal arranged in the second channel.

In some embodiments, the turbine shroud assembly may further include at least one retainer. The at least one retainer may extend axially into the carrier segment and through the attachment feature of the blade track segment so as to couple the blade track segment to the carrier segment.

According to another aspect of the present disclosure, a method may include providing a carrier segment, providing a blade track segment, and providing a buffer air seal assembly. The carrier segment may be arranged circumferentially at least partway around an axis. The blade track segment may be arranged circumferentially at least partway around the axis

In some embodiments, the carrier segment may be formed to include a radially-inwardly opening first channel and at least one buffer air passageway. The at least one buffer air passageway may extend radially into the carrier segment and opens into the first channel.

In some embodiments, the blade track segment having a shroud wall and an attachment feature. The shroud wall may extend circumferentially partway around the axis. The attachment feature may extend radially outward from the shroud wall.

In some embodiments, the buffer air seal assembly may include a first seal member, a second seal member, and a sled member. Each of the first seal member, the second seal member, and the sled member may each extend circumferentially relative to the axis.

In some embodiments, the method may further include arranging the buffer air seal assembly in the radially-inwardly opening first channel formed in the carrier segment. The buffer air seal assembly may be arranged in the radially-inwardly opening first channel formed in the carrier segment so that the sled member is located radially outward of and axially between the first and second seal members.

In some embodiments, the method may further include arranging the blade track segment adjacent to the carrier segment. The blade track segment may be arranged adjacent to the carrier segment so that the buffer air seal assembly is radially between the carrier segment and the shroud wall of the blade track segment to block gases in from flowing between the carrier segment and the blade track segment.

In some embodiments, the method may further include biasing the sled member radially inward. The sled member may be biased radially inward to urge the first seal member radially inward and axially forward and the second seal member radially inward and axially aft into engagement with the carrier segment and the shroud wall of the blade track segment.

In some embodiments, the method may further include discharging a flow of buffer air through the at least one buffer air passageway. The method may further include discharging a flow of buffer air through the at least one buffer air passageway into the first channel.

In some embodiments, the sled may have one of a semi-circle cross-sectional shape, a triangular cross-sectional shape, and a trapezoidal cross-sectional shape when viewed in a circumferential direction. In some embodiments, the sled may have a semi-circle cross-sectional shape when viewed in a circumferential direction. In some embodiments, the sled may have a triangular cross-sectional shape when viewed in a circumferential direction. In some embodiments, the sled may have one of a trapezoidal cross-sectional shape when viewed in a circumferential direction.

In some embodiments, the sled member may be formed to include at least one through hole. The at least one through hole may extend radially therethrough to allow the flow of buffer air to flow through the sled member.

In some embodiments, the first seal member and the second seal member may each comprise a single strand of solid metallic material. The first seal member may comprise a single strand of solid metallic material. The second seal member may comprise a single strand of solid metallic material.

In some embodiments, the first channel may be formed to define an end surface, a first side surface, and a second side surface. The end surface may extend axially. The first side surface may extend radially inward and axially forward from the end surface. The second side surface may extend radially inward and axially aft from the end surface. The sled member may urge the first seal member radially inward and axially forward into the first side surface of the first channel. The sled member may urge the second seal member radially inward and axially aft into the second side surface of the first channel.

In some embodiments, the method may further include providing at least one retainer and inserting the at least one retainer axially into the carrier segment and through the attachment feature of the blade track segment. The method may include inserting the at least one retainer axially into the carrier segment and through the attachment feature of the blade track segment to couple the blade track segment to the carrier segment.

These and other features of the present disclosure will become more apparent from the following description of the illustrative embodiments.

### BRIEF DESCRIPTION OF THE DRAWINGS

FIG. 1 is a cut-away perspective view of a gas turbine engine showing that the exemplary engine includes a fan, a compressor, a combustor, and a turbine and suggesting that the turbine includes turbine wheel assemblies and static vane assemblies surrounded by a turbine shroud assembly;

FIG. 2 is a partial cross-sectional view of the gas turbine engine of FIG. 1 showing a portion of the turbine in which the turbine shroud assembly is located radially outward from blades of a turbine wheel assembly to block gasses from passing over the blades without interacting with the blades, and further showing the turbine shroud assembly includes a carrier segment, a blade track segment coupled to the carrier segment to define a portion of a gas path of the gas turbine engine, and a seal system configured to seal between the carrier segment and the blade track segment to block gases flowing through the gas path from flowing between the carrier segment and the blade track segment;

FIG. 3 is a perspective view of a portion of the turbine shroud assembly of FIG. 2 showing the turbine shroud assembly includes the carrier segment and the blade track segment made from ceramic matrix composite materials coupled to the carrier segment;

FIG. 4 is an exploded view of the turbine shroud assembly of FIG. 3 showing the seal system includes a forward seal assembly—also referred to as a buffer air seal assembly—configured to be arranged in a first channel formed in a forward support wall of the carrier segment and an aft seal assembly configured to be arranged in a second channel formed in an aft support wall of the carrier segment;

FIG. 5 is a cross-sectional view of the turbine shroud assembly of FIG. 3 taken along line 5-5 showing the forward support wall of the carrier segment is formed to include a radially-inwardly opening first channel that receives the forward seal assembly, a radially-inwardly opening second channel that receives the aft seal assembly, and a buffer air passageway configured to discharge buffer air axially into the first channel, and further showing the forward seal assembly includes a first seal member, a second seal member spaced apart axially from the first seal member, a sled member located radially outward of and axially between the first and second seal members, and a bias member that applies a bias force to the sled member to urge the sled member radially inward to cause the first seal member to be pushed radially inward and axially forward and the second seal members to be pushed radially inward and axially aft into engagement with the carrier segment and the blade track segment;

FIG. 6 is a detail view of FIG. 5 showing the sled member and the bias member may each be formed to include through holes that extend radially therethrough to allow the buffer air discharged into the first channel by the buffer air passageway to flow through the sled member and the bias member;

FIG. 7 is a cross-sectional view of the turbine shroud assembly of FIG. 3 taken along line 7-7 showing the forward support wall is formed to include a plurality of buffer air passageways spaced apart circumferentially about the axis, and further showing each buffer air passageway extends radially into the forward support wall of the carrier segment from a cavity formed in the outer wall of the carrier segment;

FIG. 8 is a radially-inward view of the bias member included in the forward seal assembly of the turbine shroud assembly of FIG. 3 showing the bias member may be formed to include scalloped edges to allow the buffer air to flow around the bias member;

FIG. 9 is an exploded view of another turbine shroud assembly included in the gas turbine engine of FIG. 1 showing the turbine shroud assembly includes a carrier segment, a blade track segment, and a seal system having a forward seal assembly configured to be arranged in a first channel formed in a forward support wall of the carrier segment and an aft seal assembly configured to be arranged in a second channel formed in an aft support wall of the carrier segment;

FIG. 10 is a cross-sectional view of the turbine shroud assembly of FIG. 9 showing the forward seal assembly includes a first seal member, a second seal member spaced apart axially from the first seal member, a sled member having a trapezoidal cross-sectional shape located radially outward of and axially between the first and second seal members, and a bias member that applies a bias force to the sled member;

FIG. 11 is a detail view of FIG. 10 showing the trapezoidal sled member may be formed to include through holes that extend radially therethrough to allow the buffer air discharged into the first channel by the buffer air passageway to flow through the sled member;

FIG. 12 is a cross-sectional view of the turbine shroud assembly of FIG. 9 showing the sled member may be formed to include notches spaced apart circumferentially along the sled member that each extend into an outer surface of the sled member and receive portions of the bias member to locate the bias member relative to the sled member;

FIG. 13 is an exploded view of another turbine shroud assembly included in the gas turbine engine of FIG. 1 showing the turbine shroud assembly includes a carrier segment, a blade track segment, and a seal system having a forward seal assembly configured to be arranged in a first channel formed in a forward support wall of the carrier segment and an aft seal assembly configured to be arranged in a second channel formed in an aft support wall of the carrier segment;

FIG. 14 is a cross-sectional view of the turbine shroud assembly of FIG. 13 showing the forward seal assembly includes a first seal member, a second seal member spaced apart axially from the first seal member, a sled member having a trapezoidal cross-sectional shape located radially outward of and axially between the first and second seal member, and a bias member that applies a bias force to the sled member;

FIG. 15 is a detail view of FIG. 14 showing the sled member may be formed to include through holes that extend radially therethrough to allow the buffer air discharged into the first channel by the buffer air passageway to flow through the sled member; and

FIG. 16 is a cross-sectional view of the turbine shroud assembly of FIG. 13 showing the bias member is segmented and the segments are spaced apart circumferentially relative to the axis;

FIG. 17 is an exploded view of another turbine shroud assembly included in the gas turbine engine of FIG. 1 showing the turbine shroud assembly includes a carrier segment, a blade track segment, and a seal system having a forward seal assembly configured to be arranged in a first channel formed in a forward support wall of the carrier segment and an aft seal assembly configured to be arranged in a second channel formed in an aft support wall of the carrier segment;

FIG. 18 is a cross-sectional view of the turbine shroud assembly of FIG. 17 showing the forward seal assembly includes a first seal member, a second seal member spaced apart axially from the first seal member, and a sled member having a trapezoidal cross-sectional shape located radially outward of and axially between the first and second seal members that is bias radially inward by the buff air discharged into the first channel;

FIG. 19 is a detail view of FIG. 18 showing the trapezoidal sled member may be formed to include through holes that extend radially therethrough to allow the buffer air discharged into the first channel by the buffer air passageway to flow through the sled member; and

FIG. 20 is a cross-sectional view of the turbine shroud assembly of FIG. 17 showing the sled member is formed to include a plurality of through holes that are spaced apart circumferentially relative to the axis.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

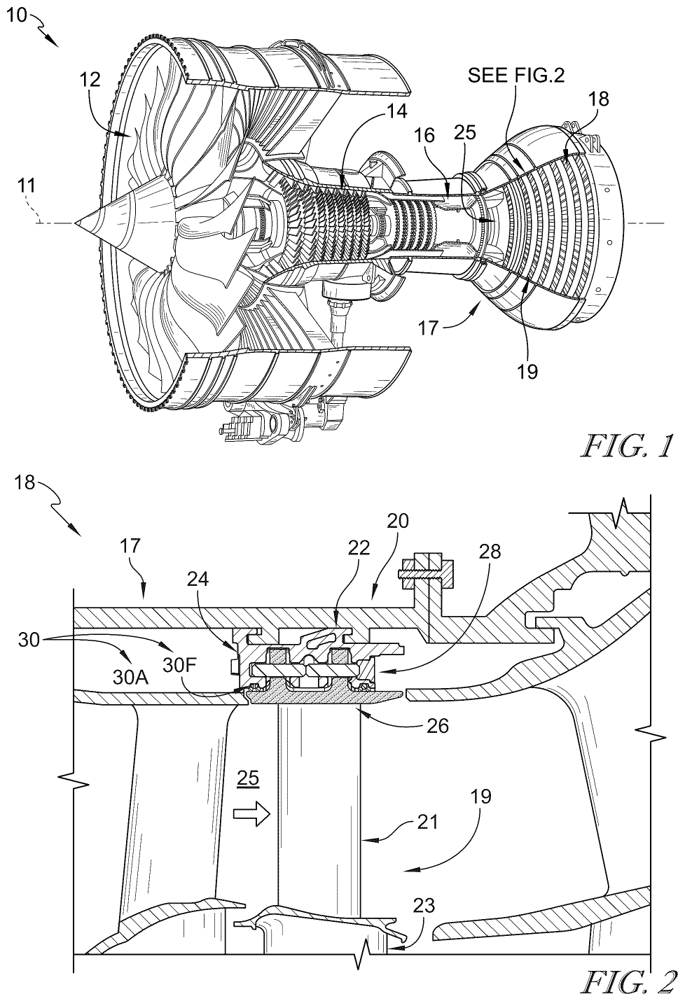

A turbine shroud segment 22 is shown in FIGS. 2-6 and is adapted for use in a gas turbine engine 10 as shown in FIG. 1. The turbine shroud segment 22 includes a carrier segment 24 arranged circumferentially at least partway around an axis 11 of the gas turbine engine 10, a blade track segment 26 arranged circumferentially at least partway around the axis 11, a mount system 28 configured to couple the carrier segment 24 to the blade track segment 26, and a seal system 30 as shown in FIGS. 2-6. The seal system 30 is configured to seal gaps between the carrier segment 24 and the blade track segment 26 to prevent or block gases from a gas path 25 of the gas turbine engine 10 from flowing between the carrier segment 24 and the blade track segment 26.

The blade track segment 26 is a ceramic matrix composite component configured to directly face the high temperatures of the gas path 25 of the gas turbine engine 10 to define a portion of the gas path 25. The carrier segment 24 is a metallic support component configured to interface with other metallic components of the gas turbine engine 10, such as the case 17, to support the blade track segment 26 to radially locate the blade track segment 26 relative to the axis 11. The mount system 28 includes at least one retainer 78, 80, and illustratively the mount system 28 includes two retainers 78, 80 that each extend axially into the blade track segment 26 and the carrier segment 24 to couple the blade track segment 26 to the carrier segment 24. The seal system 30 is arranged radially between the carrier segment 24 and the blade track segment 26 to seal a cavity 48 (sometimes referred to as an attachment-receiving space) defined by the carrier segment 24 to block gases from flowing between the carrier segment 24 and the blade track segment 26 and into the cavity 48.

The seal system 30 includes a forward seal assembly 30F located radially between the carrier segment 24 and the blade track segment 26 on a forward side of the blade track segment 26 and an aft seal assembly 30A located radially between the carrier segment 24 and the blade track segment 26 on an aft side of the blade track segment 26. The forward seal assembly 30F—also referred to as the buffer air seal assembly—is arranged in a radially-inwardly opening first channel 52, while the aft seal assembly 30A is arranged in a radially-inwardly opening second channel 54.

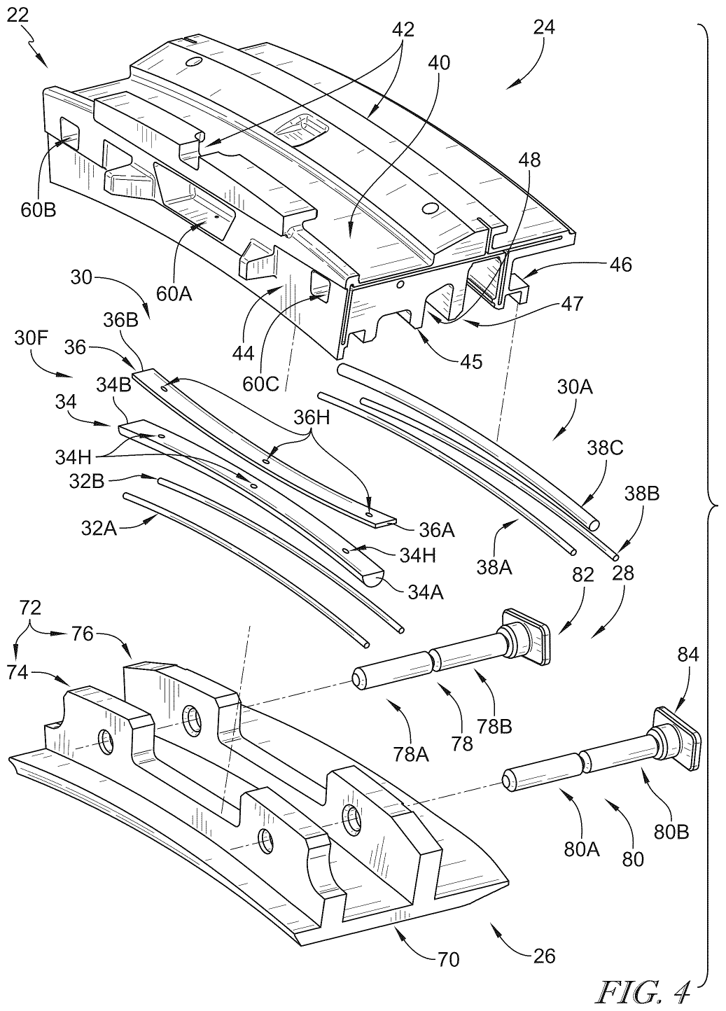

The forward seal assembly 30F includes a first seal member 32A, a second seal member 32B, and a sled member 34 as shown in FIGS. 4-7. The first seal member 32A, the second seal member 32B, and the sled member 34 each extend circumferentially about the axis 11. The sled member 34 is located radially outward of and axially between the first and second seal members 32A, 32B and biased radially inward toward the blade track segment 26 to urge the first seal member 32A radially inward and axially forward and the second seal member 32B radially inward and axially aft into engagement with the carrier segment 24 and the blade track segment 26.

During operation of a gas turbine engine 10, the hot, high-pressure products directed into the turbine 18 from the combustor 16 flow across a radially-inwardly opening surface of a shroud wall 70 of the blade track segment 26 that defines a portion of the gas path 25. The seal system 30 blocks the hot, high-pressure products from flowing into the cavity 48 of the turbine shroud segment 22. Some turbine shroud assemblies use seals having at least two seal members, where one of the seals is configured to be compressed between the carrier segment 24 and the blade track segment 26 to bias the other seal member(s) into engagement with the shroud wall 70 of the blade track segment 26, thereby improving the seal therebetween.

In some embodiments, the carrier segment 24 may also include buffer air passageways to direct relatively high-pressure air (sometimes referred to as buffer air) into the channel(s) formed in the carrier segment 24 to distribute the high-pressure air along the seal members. The high-pressure air supplied to the channel(s) is used help keep the gases in the gas path 25 out of the cavity 48 in the event of a seal failure. The high-pressure or buffer air is usually jetted through the seal members arranged in the channel(s), which may cause the seal members to wear, specifically oxidize, significantly reducing the overall life of the seal members and the effectiveness of the seal members.

Instead of using another compressible seal member, like a braid seal, to urge the other seal member(s) into engagement with the shroud wall 70 of the blade track segment 26, the buffer air seal assembly 30F includes the sled member 34 made of solid metallic material. The sled member 34 is biased radially inwards to urge the first seal member 32A radially inward and axially forward and the second seal member 32B radially inward and axially aft into engagement with the carrier segment 24 and the blade track segment 26.

In the illustrative embodiment, the buffer air seal assembly 30F includes a bias member 36 compressed radially between the carrier segment 24 and the sled member 34 to apply a bias force to the sled member 34 to bias the sled member 34 radially inward towards the shroud wall 70 of the blade track segment 26 as shown in FIGS. 4-8.

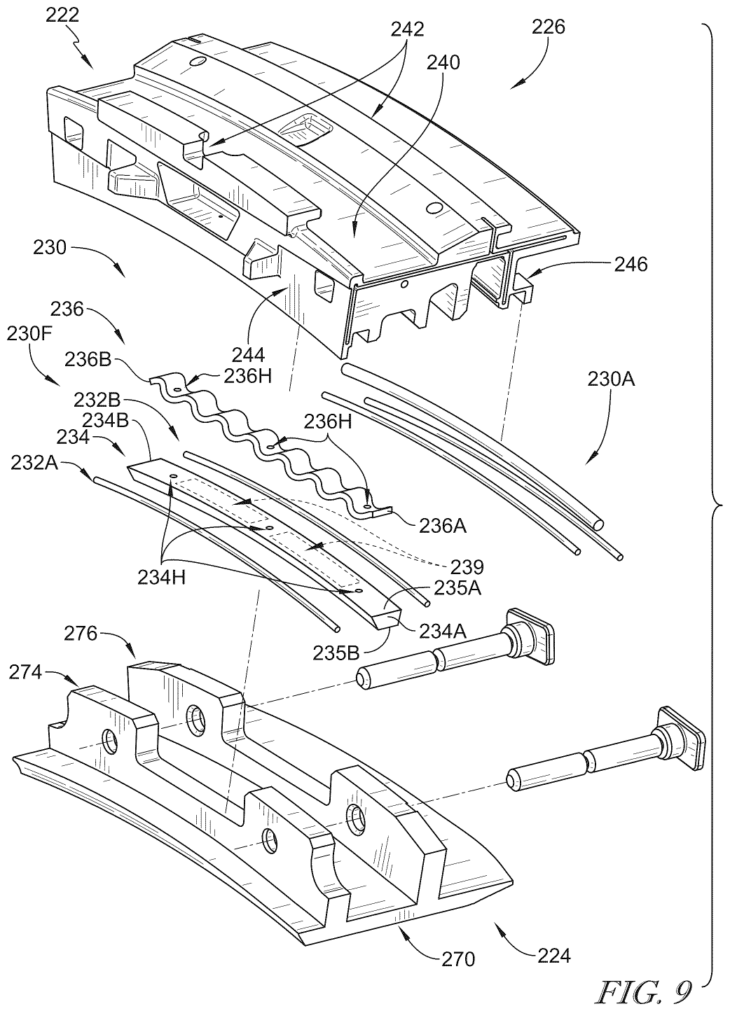

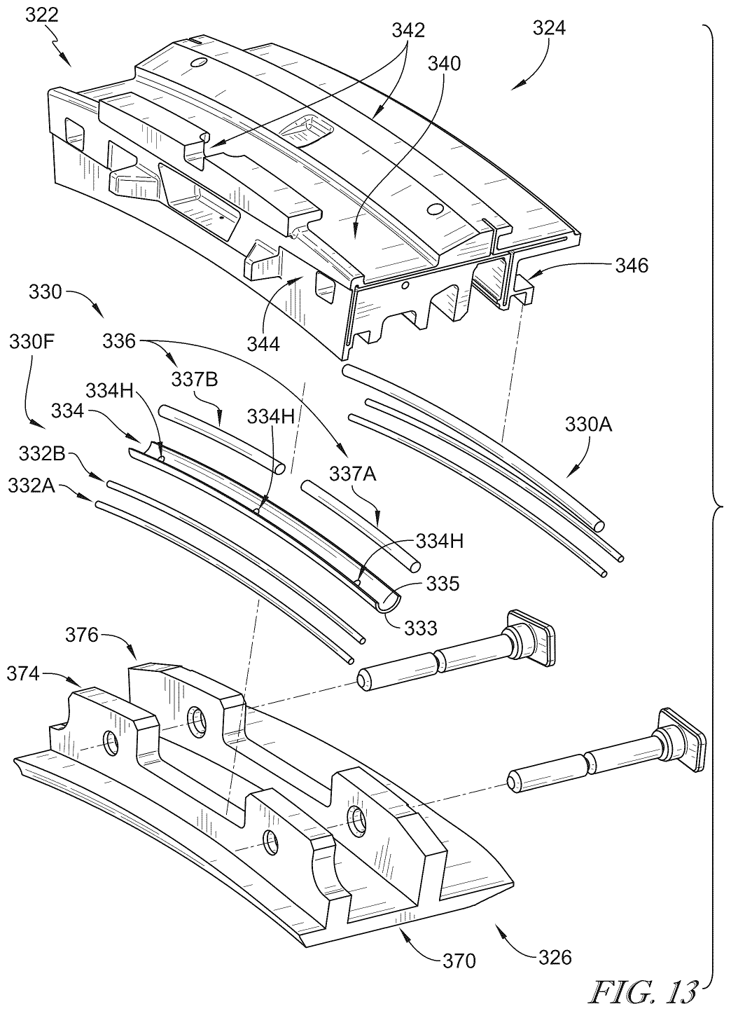

The bias member 36 is a spring in the illustrative embodiment. In some embodiments, the bias member 36 is a leaf spring. In some embodiments, the bias member 36 may be a wave spring, like the bias member 236 as shown in FIGS. 9-12. In some embodiments, bias member 36 may be another suitable spring type to bias the sled member 34. In some embodiments, the buffer air may be used to pressurize the channel thereby biasing the sled member radially inward like as shown in FIGS. 13-16.

The buffer air seal assembly 30F includes the first seal member 32A, the second seal member 32B, the sled member 34, and the bias member 36 as shown in FIGS. 4-8. The sled member 34 is located radially outward of and axially between the first and second seal members 32A, 32B. The bias member 36 biases the sled member 34 radially inward toward the blade track segment 26 to urge the first seal member 32A radially inward and axially forward and the second seal member 32B radially inward and axially aft into engagement with the carrier segment 24 and the blade track segment 26.

The first and second seal members 32A, 32B are each a wire seal or a single strand of solid metallic material. The sled member 34 is made of solid metallic material. The bias member 36 is a flat spring that is compressed between the carrier segment 24 and the sled member 34 to bias the sled member 34 radially inward.

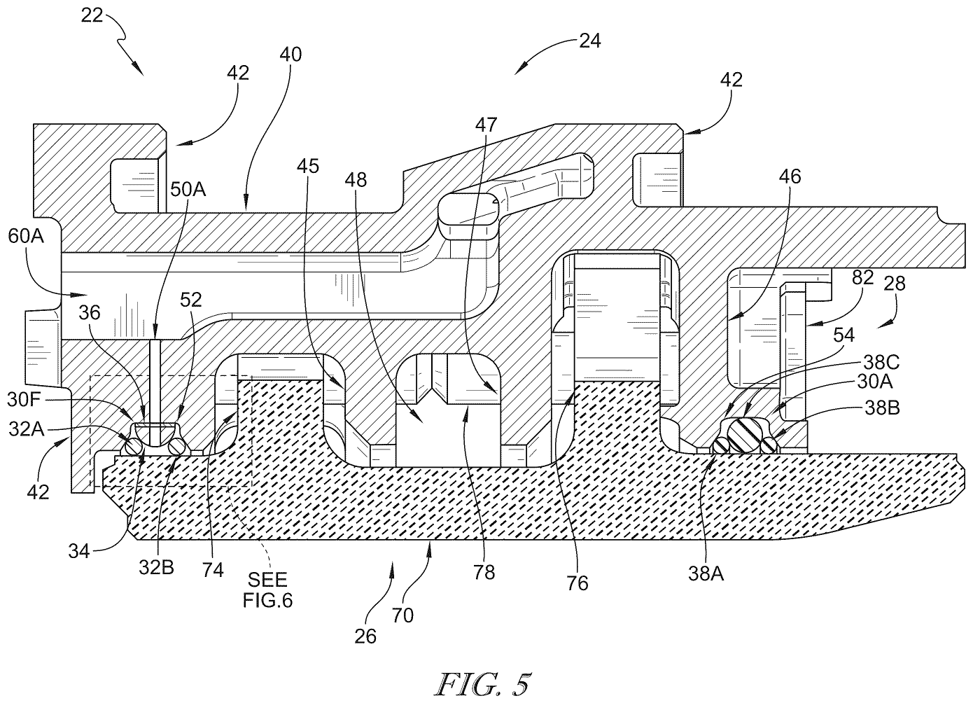

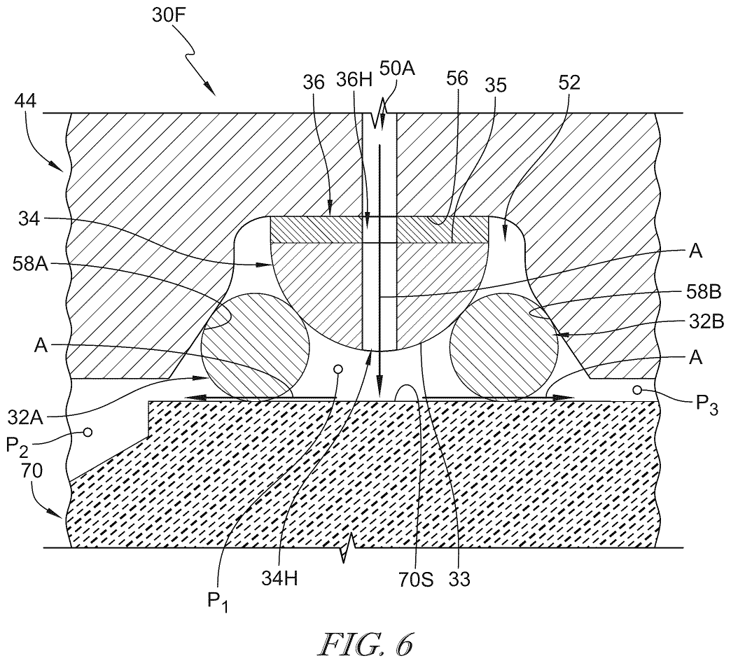

The sled member 34 has a semi-circular cross-sectional shape when viewed in the circumferential direction as shown in FIGS. 5 and 6. The curved surface 33 of the sled member 34 engages the first and second seal members 32A, 32B. The other surface 35 of the sled member 34 is relatively planar and faces the bias member 36. The bias member 36 is compressed between the carrier segment 24 and the surface 35 of the sled member 34 to bias the sled member 34 radially inward.

The sled member 34 urges the first seal member 32A radially inward and axially forward into engagement with the blade track segment 26 and the carrier segment 24. The sled member 34 urges the second seal member 32B radially inward and axially forward into engagement with the blade track segment 26 and the carrier segment 24. The buffer air is discharged into the channel 52 through the buffer air passageways 50A, 50B, 50C formed in carrier segment 24 as suggested by arrows A in FIGS. 5 and 6. The buffer air may leak across the seal members 32A, 32B as suggested by the arrows A in FIG. 6 to help keep gases from flowing into the cavity 48.

The sled member 34 extends between a first circumferential end 34A and a second circumferential end 34B spaced apart from the first circumferential end 34A as shown in FIG. 4. In the illustrative embodiment, the sled member 34 is formed to include at least one through hole 34H that extends radially through the sled member 34 between the ends 34A, 34B of the sled member 34 as shown in FIGS. 4 and 6. The through hole 34H extends radially through the sled member 34 to allow the buffer air to flow through the sled member 34 as suggested by the arrow in FIG. 6.

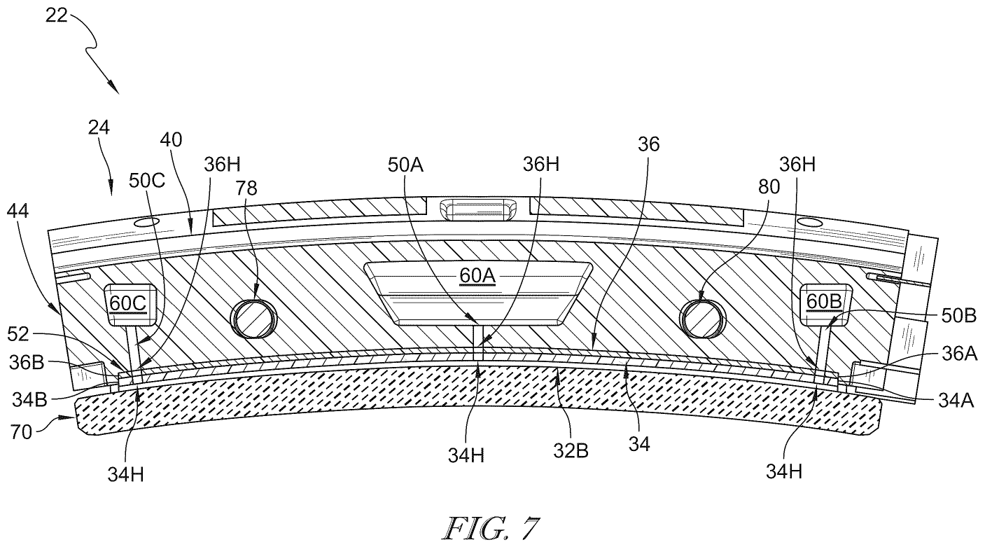

In the illustrative embodiment, the sled member 34 is formed to include a plurality of through holes 34H as shown in FIGS. 4 and 7. The through holes 34H are spaced apart circumferentially along the sled member 34 between the first and second circumferential ends 34A, 34B. Each of the through holes 34H extends radially through the sled member 34 to allow the buffer air to flow through the sled member 34.

The bias member 36 extends between a first circumferential end 36A and a second circumferential end 36B spaced apart from the first circumferential end 36A as shown in FIGS. 4, 7, and 8. The bias member 36 has edges 36C, 36D that extend between and interconnect the first and second circumferential ends 36A, 36B.

In the illustrative embodiment, the bias member 36 is formed to include at least one through hole 36H as shown in FIGS. 4 and 6. The through hole 36H extends radially through the bias member 36 to allow the buffer air to flow through the bias member 36 as suggested by the arrow in FIG. 6.

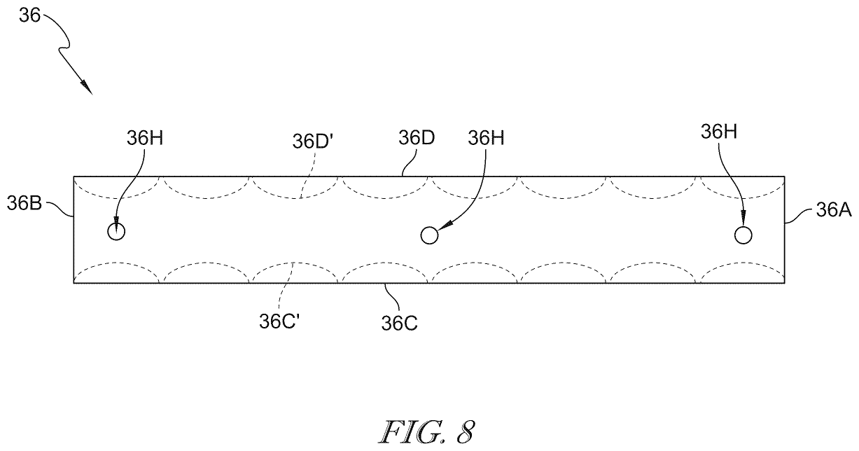

In the illustrative embodiment, the bias member 36 is formed to include a plurality of through holes 36H as shown in FIGS. 4 and 8. The through holes 34H are spaced apart circumferentially along the sled member 34 between the first and second circumferential ends 34A, 34B. Each of the through holes 34H extends radially through the sled member 34 to allow the buffer air discharged into the channel 52 by the buffer air passageways 50A, 50B, 50C to flow through the sled member 34 as well as around the sled member 34.

The through holes 34H in the sled member 34 may align circumferentially with the through holes 36H in the bias member 36 in some embodiments like as shown in FIGS. 6 and 7. In some embodiments, the through holes 34H in the sled member 34 may be offset circumferentially from the through holes 36H in the bias member 36.

In some embodiments, the edges 36C, 36D of the bias member 36 are scalloped 36C′, 36D′ as suggested in FIG. 8. The scalloped edges 36C′, 36D′ may allow the buffer air to more easily flow around the bias member 36.

With the seal system 30 of the present disclosure initially described above, the gas turbine engine 10 is now described in more detail. The gas turbine engine 10 includes a fan 12, a compressor 14, a combustor 16, and a turbine 18 as shown in FIG. 1. The fan 12 is driven by the turbine 18 and provides thrust for propelling an air vehicle. The compressor 14 compresses and delivers air to the combustor 16. The combustor 16 mixes fuel with the compressed air received from the compressor 14 and ignites the fuel. The hot, high-pressure products of the combustion reaction in the combustor 16 are directed into the turbine 18 to cause the turbine 18 to rotate about an axis 11 and drive the compressor 14 and the fan 12. In some embodiments, the fan may be replaced with a propeller, drive shaft, or other suitable configuration.

The turbine 18 includes at least one turbine wheel assembly 19 and a turbine shroud 20 positioned to surround the turbine wheel assembly 19 as shown in FIGS. 1 and 2. The turbine wheel assembly 19 includes a plurality of blades 21 coupled to a rotor disk 23 for rotation with the disk 23. The hot, high pressure combustion products from the combustor 16 are directed toward the blades 21 of the turbine wheel assemblies 19 along the gas path 25. The turbine shroud 20 is coupled to the outer case 17 of the gas turbine engine 10 and extends around the turbine wheel assembly 19 to block gases from passing over the turbine blades 21 during use of the turbine 18 in the gas turbine engine 10.

In the illustrative embodiment, the turbine shroud 20 is made up of a number of turbine shroud segment assemblies 22 that each extend circumferentially partway around the axis 11 and cooperate to surround the turbine wheel assembly 19. In other embodiments, the turbine shroud 20 is annular and non-segmented to extend fully around the axis 11 and surround the turbine wheel assembly 19. In yet other embodiments, certain components of the turbine shroud 20 are segmented while other components are annular and non-segmented.

Each turbine shroud segment 22 includes the carrier segment 24, blade track segment, the mount system 28, and the seal system 30 as shown in FIGS. 2-6. The carrier segment 24 and the blade track segment 26 are arranged circumferentially partway about the axis 11. The blade track segment 26 includes the shroud wall 70 that extends circumferentially partway around the axis 11 to define a portion of the gas path 25 and an attachment feature 72 that extends radially from the shroud wall 70 into the cavity 48 of the carrier segment 24. The mount system 28 is configured to couple the blade track segment 26 to the carrier segment 24. The seal system 30 is arranged radially between the carrier segment 24 and the blade track segment 26 to seal gaps therebetween.

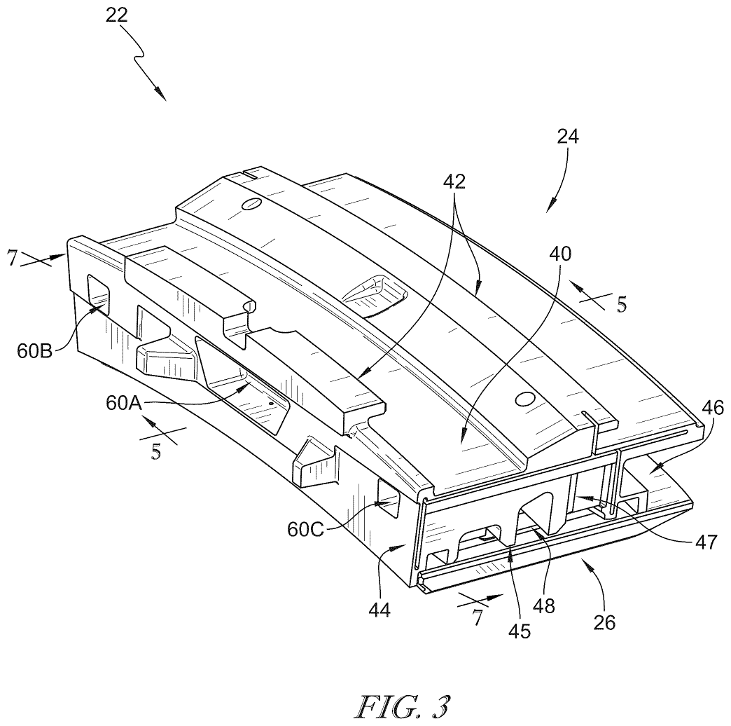

The carrier segment 24 includes an outer wall 40, a pair of hangers 42, a forward support wall 44, and an aft support wall 46 as shown in FIGS. 3-6. The outer wall 40 extends circumferentially at least partway about the axis 11. The hangers 42 extend radially outward from the outer wall 40 and engage the case 17 to couple the turbine shroud segment 22 to the rest of the engine 10. The forward support wall 44 extends radially inward from the outer wall 40 at a forward end of the outer wall 40 axially forward of the attachment feature 72 and the aft support wall 46 extends radially inward from the outer wall 40 at an aft end of the outer wall 40 axially aft of the attachment feature 72.

In the illustrative embodiment, the carrier segment 24 further includes a first intermediate support wall 45 and a second intermediate support wall 47 as shown in FIGS. 3, 4, and 6. The first intermediate support wall 45 and the second intermediate support wall 47 each extend radially inward from the outer wall 40 of the carrier segment 24 axially between the first and second support walls 44, 46. The second intermediate support wall 47 is spaced apart axially from the first intermediate support wall 45 in the illustrative embodiment.

The forward and aft support walls 44, 46 of the carrier segment 24 each include channels 52, 54 as shown in FIGS. 5-7. The forward support wall 44 is formed to include the first channel 52 and the aft support wall 46 is formed to include the second channel 54.

In the illustrative embodiment, only the forward support wall 44 includes the buffer air passageway 50A, 50B, 50C as shown in FIGS. 5-7. The forward support wall 44 includes at least one discrete buffer air passageway 50A, 50B, 50C that extends radially into the forward support wall 44 and opens into the first channel 52. In the illustrative embodiment, the forward support wall 44 includes a plurality of buffer air passageways 50A, 50B, 50C that are spaced apart circumferentially about the axis 11 as shown in FIG. 7.

In the illustrative embodiment, each buffer air passageway 50A, 50B, 50C extends from an outer cavity 60A, 60B, 60C formed in the outer wall 40 of the carrier segment 24 as shown in FIGS. 5 and 7. The buffer air flows from the outer cavity 60A, 60B, 60C to the buffer air passageways 50A, 50B, 50C. In some embodiments, the carrier segment 24 is formed to include an outer cavity 60A, 60B, 60C for each buffer air passageway 50A, 50B, 50C that supplies the corresponding buffer air passageway 50A, 50B, 50C with buffer air.

In the illustrative embodiment, the first channel 52 is defined by an end surface 56, a first side surface 58A, and a second side surface 58B as shown in FIG. 6. The end surface 56 extends axially and faces radially-inwardly toward the blade track segment 26. The first side surface 58A extends radially inward and axially forward from the end surface 56. The second side surface 58B extends radially inward and axially aft from the end surface 56. The sled member 34 urges the first seal member 32A radially inward and axially forward into the first side surface 58A of the first channel 52 and urges the second seal member 32B radially inward and axially aft into the second side surface 58B of the first channel 52.

The blade track segment 26 includes the shroud wall 70 and the attachment feature 72 as shown in FIGS. 4-6. The shroud wall 70 that extends circumferentially partway around the axis 11. The attachment feature 72 includes a first attachment flange 74 and a second attachment flange 76 that each extend radially outward from the shroud wall 70. The second attachment flange 76 is spaced apart axially from the first attachment flange 74.

In the illustrative embodiment, the forward support wall 44 extends radially inward from the outer wall 40 axially forward of the first attachment flange 74 of the blade track segment 26. The aft support wall 46 extends radially inward from the outer wall 40 axially aft of the second attachment flange 76 of the blade track segment 26. The first intermediate support wall 45 extends radially inward from the outer wall 40 axially aft of the first attachment flange 74 so that the first attachment flange 74 is axially between the forward support wall 44 and the first intermediate support wall 45. The second intermediate support wall 47 extends radially inward from the outer wall 40 axially forward of the second attachment flange 76 of the blade track segment 26 so that the second attachment flange 76 is located axially between the aft support wall 46 and the second intermediate support wall 47.

The mount system 28 includes at least one retainer 78, 80, illustratively two retainers 78, 80 that each extend axially into the blade track segment 26 and the carrier segment 24 to couple the blade track segment 26 to the carrier segment 24. The retainers 78, 80 extend axially into the forward support wall 44, through the first attachment flange 74, the intermediate support walls 43, 45, and the second attachment flange 76, and into the aft support wall 46 of the carrier segment 24 so as to couple the blade track segment 26 to the carrier segment 24.

In the illustrative embodiment, the mount system 28 includes the retainers 78, 80 and corresponding retainer plugs 82, 84 as shown in FIG. 4. Each of the retainer plugs 82 extends into an installation apertures formed in the aft support wall 46 to block removal of the corresponding retainers 78, 80 through the installation apertures in the carrier segment 24.

In the illustrative embodiment, the retainers 78, 80 are both split pins as shown in FIG. 4. Each retainer 78, 80 includes a first pin 78A, 80A and a second pin 78B, 80B arranged axially aft of the first pin 78A, 80A as shown in FIG. 4.

The seal system 30 includes the forward seal assembly 30F and the aft seal assembly 30A as shown in FIGS. 4-8. The forward seal assembly 30F is located radially between the carrier segment 24 and the blade track segment 26 on the forward side of the blade track segment 26 axially forward of the first attachment flange 74. The aft seal assembly 30A is located radially between the carrier segment 24 and the blade track segment 26 on the aft side of the blade track segment 26 axially aft of the second attachment flange 76. The forward seal assembly 30F or the buffer air seal assembly 30F is arranged in the first channel 52 and the aft seal assembly 30A is arranged in the second channel 54.

The forward seal assembly 30F includes the first seal member 32A, the second seal member 32B, the sled member 34, and the bias member 36 arranged in the first channel 52 as shown in FIGS. 4-8. The sled member 34 is located radially outward of and axially between the first and second seal members 32A, 32B. The bias member 36 biases the sled member 34 radially inward toward the blade track segment 26 to urge the first and second seal members 32A, 32B radially inward and forward and axially aft into engagement with the carrier segment 24 and the blade track segment 26.

In the illustrative embodiment, the sled member 34 has a semi-circular cross-sectional shape when viewed in the circumferential direction as shown in FIGS. 5 and 6. In some embodiments, the sled member 34 may have another cross-sectional shape as shown in FIGS. 9-20.

The sled member 34 urges the first seal member 32A radially inward and axially forward into engagement with the shroud wall 70 of the blade track segment 26 and the first side surface 58A of the first channel 52 formed in the carrier segment 24. The sled member 34 urges the first seal member 32A radially inward and axially forward into engagement with the shroud wall 70 of the blade track segment 26 and the first side surface 58A of the first channel 52 formed in the carrier segment 24.

The aft seal assembly 30A includes at least one seal member, and illustratively three seal members 38A, 38B, 38C arranged in the second channel 54 as shown in FIGS. 4 and 5. The third and fourth seal members 38A, 38B each extend circumferentially at least partway about the axis 11. The fifth seal member 38C is arranged radially outward of the third and fourth seal members 38A, 38B in the second channel 54.

In the illustrative embodiment, buffer air is only discharged into the first channel 52. The carrier segment 24 only includes buffer air passageways 50A, 50B, 50C at the buffer air seal assembly 30F to discharge buffer air axially into the first channel 52. In some embodiments, the carrier segment 24 may include buffer air passageways 50A, 50B, 50C that discharge buffer air into the second channel 54 at the aft seal assembly 30A.

A method of assembling and using the turbine shroud segment 22 may include several steps. The method includes arranging the seal assemblies 30F, 30A in the corresponding channels 52, 54 before arranging the blade track segment 26 adjacent to the carrier segment 24. The method includes arranging the forward seal assembly 30F in the first channel 52 and arranging the aft seal assembly 30A in the second channel 54. The seal assemblies 30F, 30A may be arranged in the corresponding channels 52, 54 in any order. In other words, the forward seal assembly 30F may be arranged in the first channel 52 first and the aft seal assembly 30A may be arranged in the second channel 54 afterwards. Alternatively, the aft seal assembly 30A may be arranged in the second channel 54 first and the forward seal assembly 30F may be arranged in the first channel 52 afterwards.

The forward seal assembly 30F is arranged in the first channel 52 so that the sled member 34 is located radially outward of and axially between the first and second seal members 32A, 32B. Arranging the forward seal assembly 30F in the first channel 52 includes several steps. First, the bias member 36 is inserted or arranged in the first channel 52. Next, the sled member 34 is inserted or arranged in the first channel 52 radially inward of the bias member 36. The sled member 34 is arranged adjacent to the bias member 36 in the first channel 52.

In some embodiments, the bias member 36 may be assembled with the sled member 34 before both are arranged in the first channel 52. The bias member 36 may be arranged on the outer surface 35 of the sled member 34 before both are arranged in the first channel 52.

Next the first and second seal members 32A, 32B are arranged in the first channel 52 radially inward of the sled member 34. The first seal member 32A is arranged in the space defined between the curved surface 33 of the sled member 34 and the first side surface 58A of the channel 52. The second seal member 32B is arranged in the space defined between the curved surface 33 of the sled member 34 and the second side surface 58B of the channel 52. The order of arranging the first and second seal members 32A, 32B may be varied. In other words, either seal member 32A, 32B may be arranged in the first channel 52 before the other.

The aft seal assembly 30A may be arranged in the second channel 54 by arranging the different seal members 38A, 38B, 38C in the second channel 54. The different seal members 38A, 38B, 38C may be inserted or arranged in the second channel 54 in any order.

Once all the seal assemblies 30F, 30A are arranged in the corresponding channels 52, 54, the blade track segment 26 is arranged adjacent to the carrier segment 24 so that the seal assemblies 30F, 30A are radially between the carrier segment 24 and the shroud wall 70 of the blade track segment 26 to block gases in the gas path from flowing between the carrier segment 24 and the blade track segment 26. The blade track segment 26 is arranged adjacent to the carrier segment 24 so that the attachment feature 72 extends into the cavity 48. The blade track segment 26 is arranged adjacent to the carrier segment 24 so that the first attachment flange 74 and the second attachment flange 76 extend into sections of the cavity 48.

In some embodiments, the method further includes inserting the retainers 78, 80 into the carrier segment 24 and the blade track segment 26 to couple the blade track segment 26 to the carrier segment 24. The method includes inserting one retainer 78 axially into the carrier segment 24 and through the attachment feature 72 of the blade track segment 26 to couple the blade track segment 26 to the carrier segment 24. The method further includes inserting another retainer 80 axially into the carrier segment 24 and through the attachment feature 72 of the blade track segment 26 to couple the blade track segment 26 to the carrier segment 24. The second retainer 80 is inserted at a location spaced apart circumferentially from the first retainer 78.

The method further includes biasing the sled member 34 radially inward to urge the first seal member 32A radially inward and axially forward and the second seal member 32B radially inward and axially aft into engagement with the carrier segment 24 and the shroud wall 70 of the blade track segment 26. The sled member 34 is biased radially inward by the bias member 36 when the blade track segment 26 is arranged adjacent to the carrier segment 24.

The method further includes discharging a flow of buffer air through the at least one buffer air passageway 50A, 50B, 50C. The flow of buffer air is suggested by arrows A. The method may further include discharging the flow of buffer air through the plurality of buffer air passageways 50A, 50B, 50C.

The buffer air discharged into the buffer air cavity defined between the seal members 32A, 32B and the sled member 34 establishes a higher pressure P₁ in the buffer air cavity than the pressure P₂ in the region axially forward of the buffer air seal assembly 30F and the pressure P₃ in the cavity 48 as shown in FIG. 6. The pressure P₃ in the cavity 48 is lower than the pressure P₂ in the region axially forward of the buffer air seal assembly 30F radially outward of the gas path 25 as shown in FIG. 6. The buffer air may be provided from the compressor 14 of the gas turbine engine 10.

Another embodiment of a turbine shroud segment 222 in accordance with the present disclosure is shown in FIGS. 9-12. The turbine shroud segment 222 is substantially similar to the turbine shroud segment 22 shown in FIGS. 1-8 and described herein. Accordingly, similar reference numbers in the 200 series indicate features that are common between the turbine shroud segment 22 and the turbine shroud segment 222. The description of the turbine shroud segment 22 is incorporated by reference to apply to the turbine shroud segment 222, except in instances when it conflicts with the specific description and the drawings of the turbine shroud segment 22.

The turbine shroud segment 222 includes a carrier segment 224 arranged circumferentially at least partway around an axis 11 of the gas turbine engine 10, a blade track segment 226 arranged circumferentially at least partway around the axis 11, and a seal system 230 as shown in FIGS. 9-12. The seal system 230 is configured to seal gaps between the carrier segment 224 and the blade track segment 226 to prevent or block gases from a gas path 25 of the gas turbine engine 10 from flowing between the carrier segment 224 and the blade track segment 226.

The seal system 230 includes a forward seal assembly 230F located radially between the carrier segment 224 and the blade track segment 226 on a forward side of the blade track segment 226 and an aft seal assembly 230A located radially between the carrier segment 224 and the blade track segment 226 on an aft side of the blade track segment 226 as shown in FIGS. 9-12. The forward seal assembly 230F—also referred to as the buffer air seal assembly—is arranged in a radially-inwardly opening first channel 252 formed in the forward support wall 244 included on the carrier segment 224, while the aft seal assembly 230A is arranged in a radially-inwardly opening second channel 254 formed in the aft support wall 246 included on the carrier segment 224.

The forward seal assembly 230F includes a first seal member 232A, a second seal member 232B, a sled member 234, and a bias member 236 as shown in FIGS. 9-12. The first seal member 232A, the second seal member 232B, and the sled member 234 each extend circumferentially about the axis 11. The sled member 234 is located radially outward of and axially between the first and second seal members 232A, 232B. The bias member 236 biases the sled member 234 radially inward toward the blade track segment 226 to urge the first seal member 232A radially inward and axially forward and the second seal member 232B radially inward and axially aft into engagement with the carrier segment 224 and the blade track segment 226.

The first and second seal members 232A, 232B are each a wire seal or a single strand of solid metallic material. The sled member 234 is made of solid metallic material. The bias member 236 is a wave spring that is compressed radially between the carrier segment 224 and the sled member 234 to apply a bias force to the sled member 234 to bias the sled member 234 radially inward towards the shroud wall 270 of the blade track segment 226.

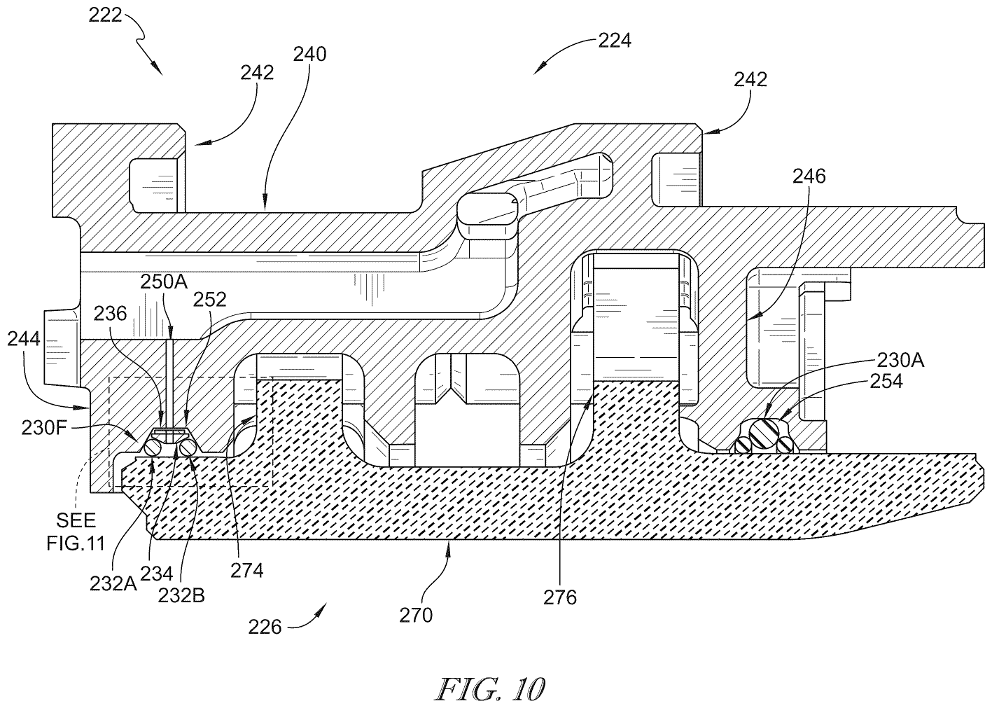

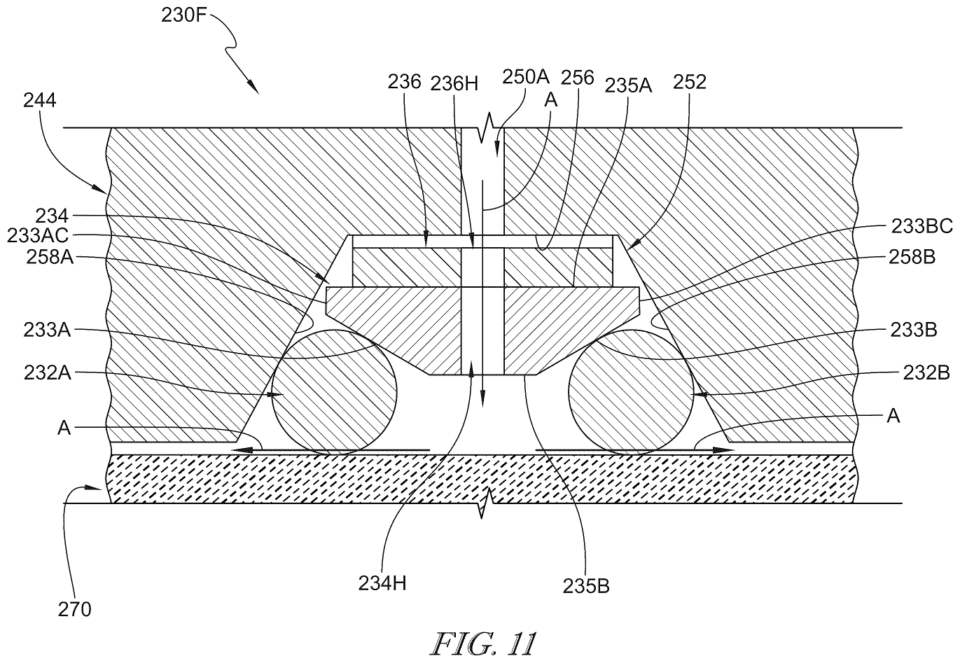

The sled member 234 has a trapezoidal cross-sectional shape when viewed in the circumferential direction as shown in FIGS. 10 and 11. The angled surfaces 233A, 233B of the sled member 234 engages the respective first and second seal members 232A, 232B. The first angled surface 233A engages the first seal member 232A and the second angled surface 233B engages the second seal member 232B. The other surfaces 235A, 235B of the sled member 234 are relatively planar. In the illustrative embodiment, the sled member 234 may have chamfer surfaces 233AC, 233BC that extend between the angled surfaces 233A, 233B and the outer surface 235A.

The outer surface 235A faces the bias member 236, while the other surface 235B faces forwards the blade track segment 226. The bias member 236 is compressed between the carrier segment 224 and the outer surface 235A of the sled member 234 to bias the sled member 234 radially inward.

In some embodiments, the sled member 234 may have another suitable cross-sectional shape. In some embodiments, the sled member 234 may have a triangular cross-sectional shape when viewed in the circumferential direction. In some embodiments, the sled member 234 may have a circular cross-sectional shape. In some embodiments, the sled member 234 may have ovular cross-sectional shape.

The sled member 234 urges the first seal member 232A radially inward and axially forward into engagement with the shroud wall 270 of the blade track segment 226 and a first side surface 258A of the first channel 252 formed in the carrier segment 224. The sled member 234 urges the second seal member 232B radially inward and axially forward into engagement with the shroud wall 270 of the blade track segment 226 and the second side surface 258B of the first channel 52 formed in the carrier segment 224.

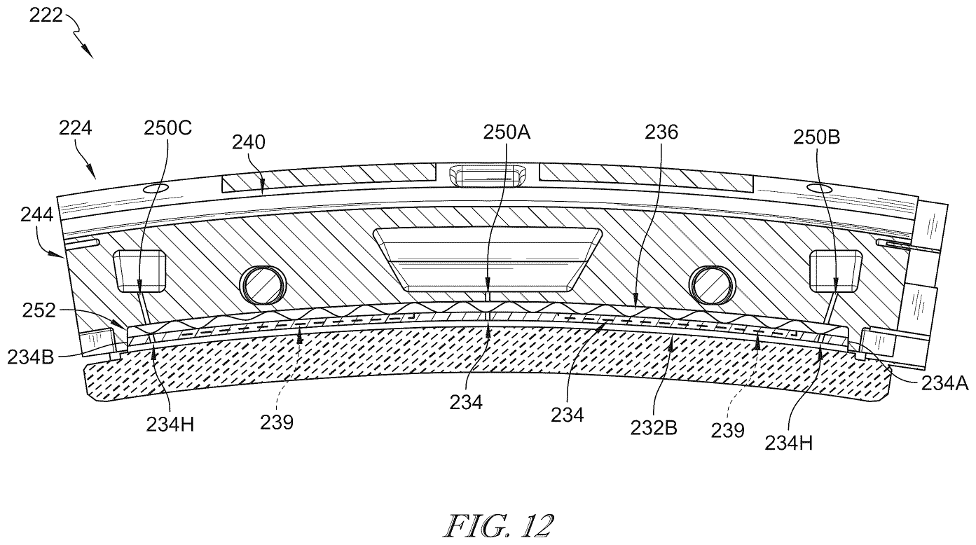

The sled member 234 extends between a first circumferential end 234A and a second circumferential end 234B spaced apart from the first circumferential end 234A as shown in FIGS. 9 and 12. In some embodiments, the sled member 234 may be formed to include notches 239 that extend into the outer surface 235A as suggested in FIGS. 9 and 12. The notches 239 may receive portions of the bias member 236 to locate the bias member 236 relative to the sled member 234. The notches 239 may prevent circumferential movement of the bias member 236 relative to the sled member 234.

In some embodiments, the circumferential length of the bias member 236 is shorter than the sled member 234. The sled member may have a circumferential length that is shorter than the seal members 232A, 232B. In some embodiments, the seal members 232A, 232B, the sled member 234, and the bias member 236 may all have the same circumferential length.

In the illustrative embodiment, the sled member 234 is formed to include at least one through hole 234H that extends radially through the sled member 234 between the ends 234A, 234B of the sled member 34 as shown in FIGS. 9 and 11. The through hole 234H extends radially through the sled member 234 to allow the buffer air to flow through the sled member 234 as suggested by the arrow in FIG. 11.

The bias member 236 extends between a first circumferential end 236A and a second circumferential end 236B spaced apart from the first circumferential end 236A as shown in FIGS. 9 and 12. In the illustrative embodiment, the bias member 236 is formed to include at least one through hole 236H as shown in FIGS. 9 and 11. The through hole 236H extends radially through the bias member 236 to allow the buffer air to flow through the bias member 236 as suggested by the arrow in FIG. 11.

In some embodiments, the bias member 236 is segmented into a plurality of bias member segments. The different segments of the bias member 236 may fit into the notches 239 formed in the sled member 234.

The carrier segment 224 includes an outer wall 240, a pair of hangers 242, the forward support wall 244, and the aft support wall 246 as shown in FIGS. 9-12. The outer wall 240 extends circumferentially at least partway about the axis 11. The hangers 242 extend radially outward from the outer wall 240. The forward support wall 244 and the aft support wall 246 each extend radially inward from the outer wall 240 on either side of the attachment flanges 274, 276.

The forward and aft support walls 244, 246 of the carrier segment 224 each include a corresponding channel 252, 254 as shown in FIGS. 10-12. The forward support wall 244 is formed to include the first channel 252 and the aft support wall 246 is formed to include the second channel 254.

In the illustrative embodiment, the first channel 252 is defined by an end surface 256, a first side surface 258A, and a second side surface 258B as shown in FIG. 11. The end surface 256 extends axially and faces radially-inwardly toward the blade track segment 226. The first side surface 258A extends radially inward and axially forward from the end surface 256. The second side surface 258B extends radially inward and axially aft from the end surface 256. The sled member 234 urges the first seal member 232A radially inward and axially forward into the first side surface 258A of the first channel 252 and urges the second seal member 232B radially inward and axially aft into the second side surface 258B of the first channel 252.

The forward support wall 244 is also formed to include buffer air passageways 250A, 250B, 250C as shown in FIGS. 10-12. Each buffer air passageway 250A, 250B, 250C extends into the forward support wall 244 and opens into the first channel 252.

A method of assembling and using the turbine shroud segment 222 may include several steps. The method includes arranging the seal assemblies 230F, 230A in the corresponding channels 252, 254 before arranging the blade track segment 226 adjacent to the carrier segment 224. The method includes arranging the forward seal assembly 230F in the first channel 252 and arranging the aft seal assembly 230A in the second channel 254.

The forward seal assembly 230F is arranged in the first channel 252 so that the sled member 234 is located radially outward of and axially between the first and second seal members 232A, 232B. Arranging the forward seal assembly 230F in the first channel 252 includes several steps. First, the bias member 236 is inserted or arranged in the first channel 252. Next, the sled member 234 is inserted or arranged in the first channel 252 radially inward of the bias member 236. The sled member 234 is arranged adjacent to the bias member 236 in the first channel 252.

In some embodiments, the bias member 236 may be assembled with the sled member 234 before both are arranged in the first channel 252. The bias member 236 may be arranged on the outer surface 235A of the sled member 234 before both are arranged in the first channel 252. The bias member 236 may be arranged on the outer surface 235A of the sled member 234 so that parts of the bias member 236 fit into the respective notches 239 on the sled member 234. Then the assembled sled member 234 and the bias member 236 may be arranged in the first channel 252.

Next the first and second seal members 232A, 232B are arranged in the first channel 252 radially inward of the sled member 234. The first seal member 232A is arranged in the space defined between the angled surface 233A of the sled member 234 and the first side surface 258A of the channel 252. The second seal member 232B is arranged in the space defined between the angled surface 233B of the sled member 234 and the second side surface 258B of the channel 252. The order of arranging the first and second seal members 232A, 232B may be varied. In other words, either seal member 232A, 232B may be arranged in the first channel 252 before the other.

Once all the seal assemblies 230F, 230A are arranged in the corresponding channels 252, 254, the blade track segment 226 is arranged adjacent to the carrier segment 224 so that the seal assemblies 230F, 230A are radially between the carrier segment 224 and the shroud wall 270 of the blade track segment 226 to block gases in the gas path from flowing between the carrier segment 224 and the blade track segment 226. The method further includes biasing the sled member 234 radially inward to urge the first seal member 232A radially inward and axially forward and the second seal member 232B radially inward and axially aft into engagement with the carrier segment 224 and the shroud wall 270 of the blade track segment 226. The sled member 234 is biased radially inward by the bias member 236 when the blade track segment 226 is arranged adjacent to the carrier segment 224.

The method further includes discharging a flow of buffer air through the at least one buffer air passageway 250A, 50B, 50C. The method may further include discharging the flow of buffer air through the plurality of buffer air passageways 250A, 50B, 50C.

Another embodiment of a turbine shroud segment 322 in accordance with the present disclosure is shown in FIGS. 13-16. The turbine shroud segment 322 is substantially similar to the turbine shroud segment 22 shown in FIGS. 1-8 and described herein. Accordingly, similar reference numbers in the 300 series indicate features that are common between the turbine shroud segment 22 and the turbine shroud segment 322. The description of the turbine shroud segment 22 is incorporated by reference to apply to the turbine shroud segment 322, except in instances when it conflicts with the specific description and the drawings of the turbine shroud segment 22.

The turbine shroud segment 322 includes a carrier segment 324 arranged circumferentially at least partway around an axis 11 of the gas turbine engine 10, a blade track segment 326 arranged circumferentially at least partway around the axis 11, and a seal system 330 as shown in FIGS. 13-16. The seal system 330 is configured to seal gaps between the carrier segment 324 and the blade track segment 326 to prevent or block gases from a gas path 25 of the gas turbine engine 10 from flowing between the carrier segment 324 and the blade track segment 326.

The seal system 330 includes a forward seal assembly 330F located radially between the carrier segment 324 and the blade track segment 326 on a forward side of the blade track segment 326 and an aft seal assembly 330A located radially between the carrier segment 324 and the blade track segment 326 on an aft side of the blade track segment 326 as shown in FIGS. 13-16. The forward seal assembly 330F—also referred to as the buffer air seal assembly—is arranged in a radially-inwardly opening first channel 352 formed in the forward support wall 344 included on the carrier segment 324, while the aft seal assembly 330A is arranged in a radially-inwardly opening second channel 354 formed in the aft support wall 346 included on the carrier segment 324.

The forward seal assembly 330F includes a first seal member 332A, a second seal member 332B, a sled member 334, and a bias member 336 as shown in FIGS. 13-16. The first seal member 332A, the second seal member 332B, and the sled member 334 each extend circumferentially about the axis 11. The sled member 334 is located radially outward of and axially between the first and second seal members 332A, 332B. The bias member 336 is compressed radially between the carrier segment 324 and the sled member 334 to apply a bias force to the sled member 334 to bias the sled member 334 radially inward toward the blade track segment 326 to urge the first seal member 332A radially inward and axially forward and the second seal member 332B radially inward and axially aft into engagement with the carrier segment 324 and the blade track segment 326.

The first and second seal members 332A, 332B are each a wire seal or a single strand of solid metallic material. The sled member 334 is a strip or plate of solid metallic material. The bias member 336 is a braid of metallic material, sometimes also referred to as a braid seal. The bias member 336 is a single braid of metallic material in the illustrative embodiment. In some embodiments, the bias member 336 comprises a ceramic-containing core surrounded by the braid of metallic material. The braid of metallic material may form an overbraid sheath around the ceramic core

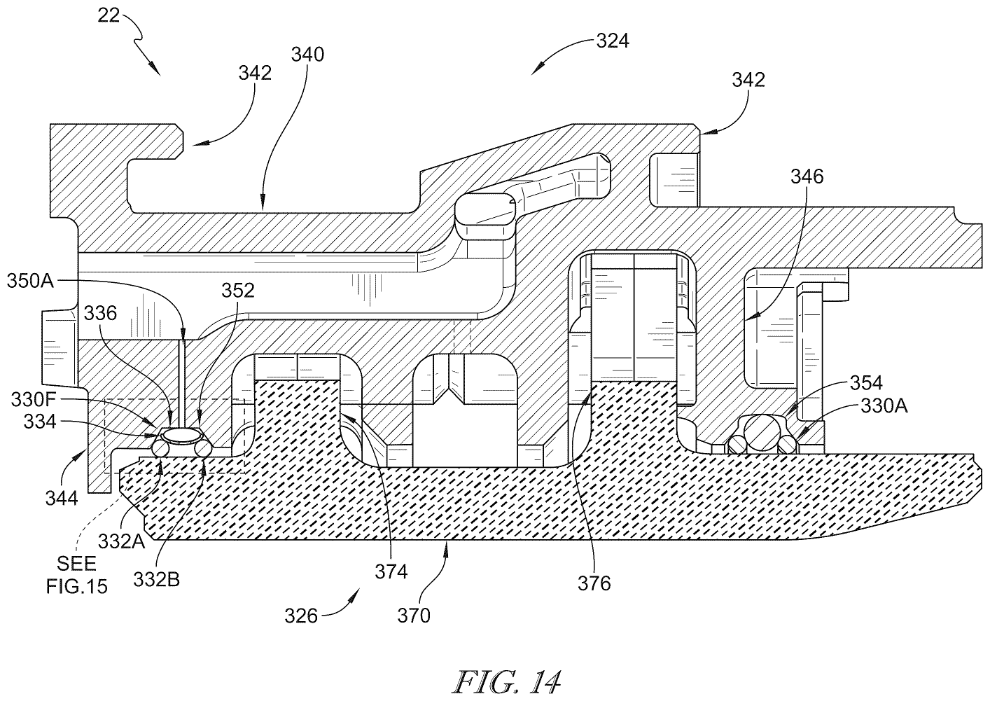

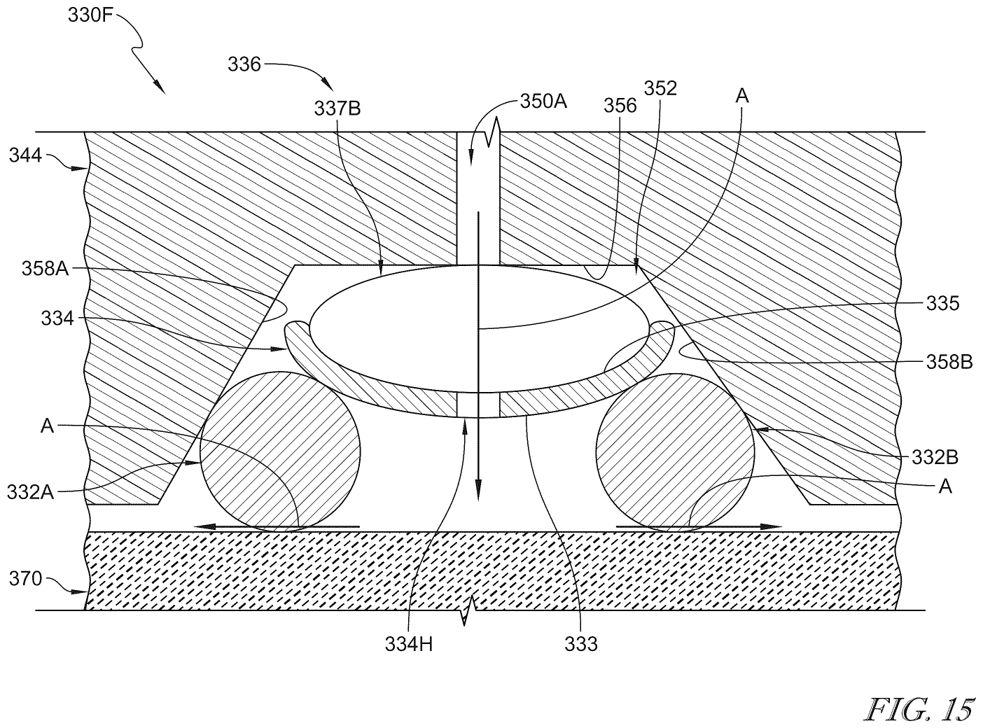

The sled member 334 has a semi-circular cross-sectional shape or u-shape when viewed in the circumferential direction as shown in FIGS. 14 and 15. The curved surface 333 of the sled member 334 engages the respective first and second seal members 332A, 332B. The other surface 335 faces the bias member 338 and creates a groove that receives the bias member 338. The bias member 336 is compressed between the carrier segment 324 and the surface 335 of the sled member 334 to bias the sled member 334 radially inward.

The sled member 334 urges the first seal member 332A radially inward and axially forward into engagement with the shroud wall 370 of the blade track segment 326 and a first side surface 358A of the first channel 352 formed in the carrier segment 324. The sled member 334 urges the second seal member 332B radially inward and axially forward into engagement with the shroud wall 370 of the blade track segment 326 and the second side surface 358B of the first channel 52 formed in the carrier segment 324.

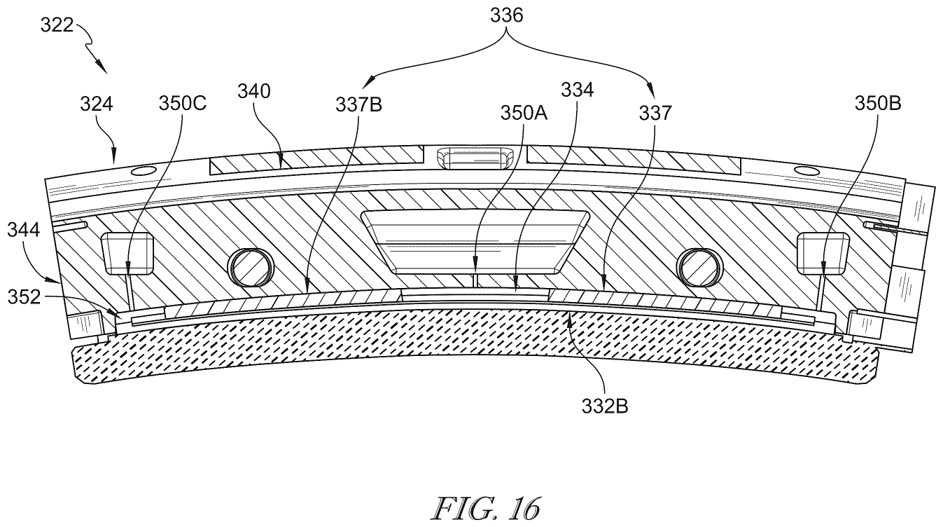

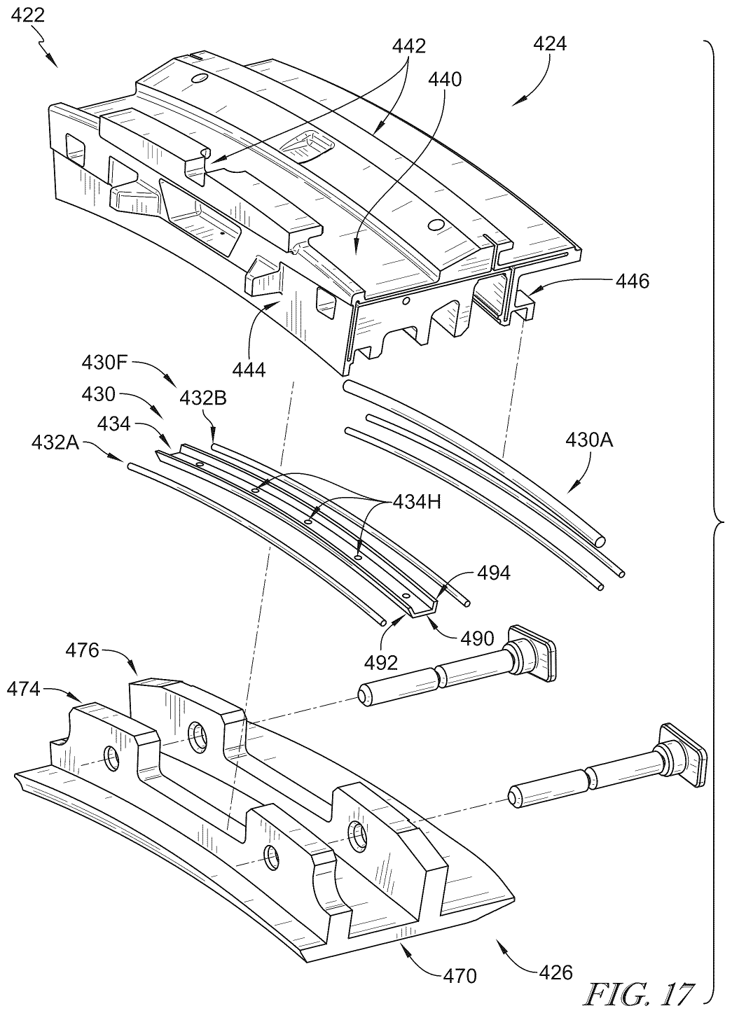

The sled member 334 extends between a first circumferential end 334A and a second circumferential end 334B spaced apart from the first circumferential end 334A as shown in FIGS. 13 and 16. In the illustrative embodiment, the sled member 334 is formed to include through holes 334H that extend radially through the sled member 334.

In the illustrative embodiment, the sled member 334 is formed to include at least one through hole 334H that extends radially through the sled member 334 between the ends 334A, 334B of the sled member 34 as shown in FIGS. 13 and 15. The through hole 334H extends radially through the sled member 334 to allow the buffer air to flow through the sled member 334 as suggested by the arrow in FIG. 15.

In the illustrative embodiment, the bias member 336 is segmented as shown in FIG. 16. Instead of having through holes like the other embodiments, the bias member 336 has a first segment 337A and a second segment 337B spaced apart circumferentially from the first segment 337A. The segments 337A, 337B of the bias member 336 are arranged circumferentially between the buffer air passageways 350A, 350B, 350C as shown in FIG. 16.

In this way, the bias member 336 is not directly in the flow path of the buffer air discharged by the buffer air passageways 350A, 50B, 50C. Instead of jetting the buffer air through or directly at the bias member 336, the buffer air passageways 350A, 50B, 50C discharge the buffer air circumferentially between the segments 337A, 337B of the bias member 336 as suggested by the arrow in FIG. 15.

The buffer air is discharged circumferentially between the segments 337A, 337B so that bias member 336 is positioned out of a flow path of the buffer air. By locating the bias member 336 out of the flow path of the discharged buffer air, the oxidation or wear of the bias member 336 is reduced, improving the life of the bias member 336.

In the illustrative embodiment the bias member 336 includes two segments 337A, 337B. In some embodiments, the bias member 336 may be segmented into more than two segments. In some embodiments, the bias member 336 may be segmented into three segments.

In some embodiments, the number of bias member segments may vary depending on the number of buffer air passageways 350A, 350B, 350C. In some embodiments, bias member 336 may be segmented and the segments 337A, 337B may also include through holes to allow air to flow therethrough.

The carrier segment 324 includes an outer wall 340, a pair of hangers 342, the forward support wall 344, and the aft support wall 346 as shown in FIGS. 13-16. The outer wall 340 extends circumferentially at least partway about the axis 11. The hangers 342 extend radially outward from the outer wall 340. The forward support wall 344 and the aft support wall 346 each extend radially inward from the outer wall 340 on either side of the attachment flanges 374, 376.

The forward and aft support walls 344, 346 of the carrier segment 324 each include a corresponding channel 352, 354 as shown in FIGS. 14-16. The forward support wall 344 is formed to include the first channel 352 and the aft support wall 346 is formed to include the second channel 354.

In the illustrative embodiment, the first channel 352 is defined by an end surface 356, a first side surface 358A, and a second side surface 358B as shown in FIG. 15. The end surface 356 extends axially and faces radially-inwardly toward the blade track segment 326. The first side surface 358A extends radially inward and axially forward from the end surface 356. The second side surface 358B extends radially inward and axially aft from the end surface 356. The sled member 334 urges the first seal member 332A radially inward and axially forward into the first side surface 358A of the first channel 352 and urges the second seal member 332B radially inward and axially aft into the second side surface 358B of the first channel 352.

The forward support wall 344 is also formed to include buffer air passageways 350A, 350B, 350C as shown in FIGS. 10-12. Each buffer air passageway 350A, 350B, 350C extends into the forward support wall 344 and opens into the first channel 352.

A method of assembling and using the turbine shroud segment 322 may include several steps. The method includes arranging the seal assemblies 330F, 330A in the corresponding channels 352, 354 before arranging the blade track segment 326 adjacent to the carrier segment 324. The method includes arranging the forward seal assembly 330F in the first channel 352 and arranging the aft seal assembly 330A in the second channel 354.

The forward seal assembly 330F is arranged in the first channel 352 so that the sled member 334 is located radially outward of and axially between the first and second seal members 332A, 332B. Arranging the forward seal assembly 330F in the first channel 352 includes several steps. First, the bias member 336 is inserted or arranged in the first channel 352. Next, the sled member 334 is inserted or arranged in the first channel 352 radially inward of the bias member 336. The sled member 334 is arranged adjacent to the bias member 336 in the first channel 352.

In some embodiments, the bias member 336 may be assembled with the sled member 334 before both are arranged in the first channel 352. The bias member 336 may be arranged on the outer surface 335A of the sled member 334 before both are arranged in the first channel 352. The bias member 336 may be arranged on the outer surface 335A of the sled member 334 so that parts of the bias member 336 fit into the respective notches 339 on the sled member 334. Then the assembled sled member 334 and the bias member 336 may be arranged in the first channel 352.

Next the first and second seal members 332A, 332B are arranged in the first channel 352 radially inward of the sled member 334. The first seal member 332A is arranged in the space defined between the angled surface 333A of the sled member 334 and the first side surface 358A of the channel 352. The second seal member 332B is arranged in the space defined between the angled surface 333B of the sled member 334 and the second side surface 358B of the channel 352. The order of arranging the first and second seal members 332A, 332B may be varied. In other words, either seal member 332A, 332B may be arranged in the first channel 352 before the other.

Once all the seal assemblies 330F, 330A are arranged in the corresponding channels 352, 354, the blade track segment 326 is arranged adjacent to the carrier segment 324 so that the seal assemblies 330F, 330A are radially between the carrier segment 324 and the shroud wall 370 of the blade track segment 326 to block gases in the gas path from flowing between the carrier segment 324 and the blade track segment 326. The method further includes biasing the sled member 334 radially inward to urge the first seal member 332A radially inward and axially forward and the second seal member 332B radially inward and axially aft into engagement with the carrier segment 324 and the shroud wall 370 of the blade track segment 326. The sled member 334 is biased radially inward by the bias member 336 when the blade track segment 326 is arranged adjacent to the carrier segment 324.

The method further includes discharging a flow of buffer air through the at least one buffer air passageway 350A, 50B, 50C. The method may further include discharging the flow of buffer air through the plurality of buffer air passageways 350A, 50B, 50C.

Another embodiment of a turbine shroud segment 422 in accordance with the present disclosure is shown in FIGS. 17-20. The turbine shroud segment 422 is substantially similar to the turbine shroud segment 22 shown in FIGS. 1-8 and described herein. Accordingly, similar reference numbers in the 400 series indicate features that are common between the turbine shroud segment 22 and the turbine shroud segment 422. The description of the turbine shroud segment 22 is incorporated by reference to apply to the turbine shroud segment 422, except in instances when it conflicts with the specific description and the drawings of the turbine shroud segment 22.

The turbine shroud segment 422 includes a carrier segment 424 arranged circumferentially at least partway around an axis 11 of the gas turbine engine 10, a blade track segment 426 arranged circumferentially at least partway around the axis 11, and a seal system 430 as shown in FIGS. 13-16. The seal system 430 is configured to seal gaps between the carrier segment 424 and the blade track segment 426 to prevent or block gases from a gas path 25 of the gas turbine engine 10 from flowing between the carrier segment 424 and the blade track segment 426.

The seal system 430 includes a forward seal assembly 430F located radially between the carrier segment 424 and the blade track segment 426 on a forward side of the blade track segment 426 and an aft seal assembly 430A located radially between the carrier segment 424 and the blade track segment 426 on an aft side of the blade track segment 426 as shown in FIGS. 17-20. The forward seal assembly 430F—also referred to as the buffer air seal assembly—is arranged in a radially-inwardly opening first channel 452 formed in the forward support wall 444 included on the carrier segment 424, while the aft seal assembly 430A is arranged in a radially-inwardly opening second channel 454 formed in the aft support wall 446 included on the carrier segment 424.

The forward seal assembly 430F includes a first seal member 432A, a second seal member 432B, and a sled member 434 as shown in FIGS. 17-20. The first seal member 432A, the second seal member 432B, and the sled member 434 each extend circumferentially about the axis 11. The sled member 434 is located radially outward of and axially between the first and second seal members 432A, 432B. The sled member 434 is biased radially inward toward the blade track segment 426 to urge the first seal member 432A radially inward and axially forward and the second seal member 432B radially inward and axially aft into engagement with the carrier segment 424 and the blade track segment 426.

In the illustrative embodiment, the buffer air discharged into the first channel 452 biases or urges the sled member 434 radially inward to engage the first and second seal members 432A, 432B. Instead of a bias member like in FIGS. 1-16, the engagement of the sled member 434 with the first and second seal members 432A, 432B creates a cavity within the first channel 452. The buffer air pressurizes the cavity to bias the sled member 434 radially inward. In some embodiments, the forward seal assembly 430F may further include a bias member to help bias the sled member 434 radially inward.

The first and second seal members 432A, 432B are each a wire seal or a single strand of solid metallic material. The sled member 434 is a strip or plate of solid metallic material.

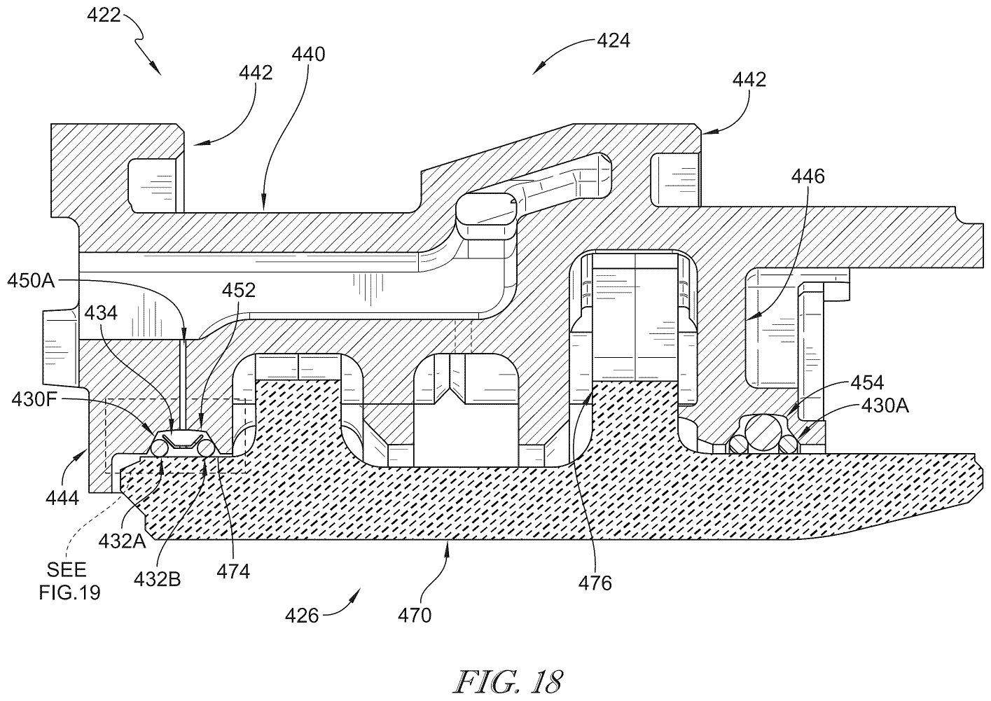

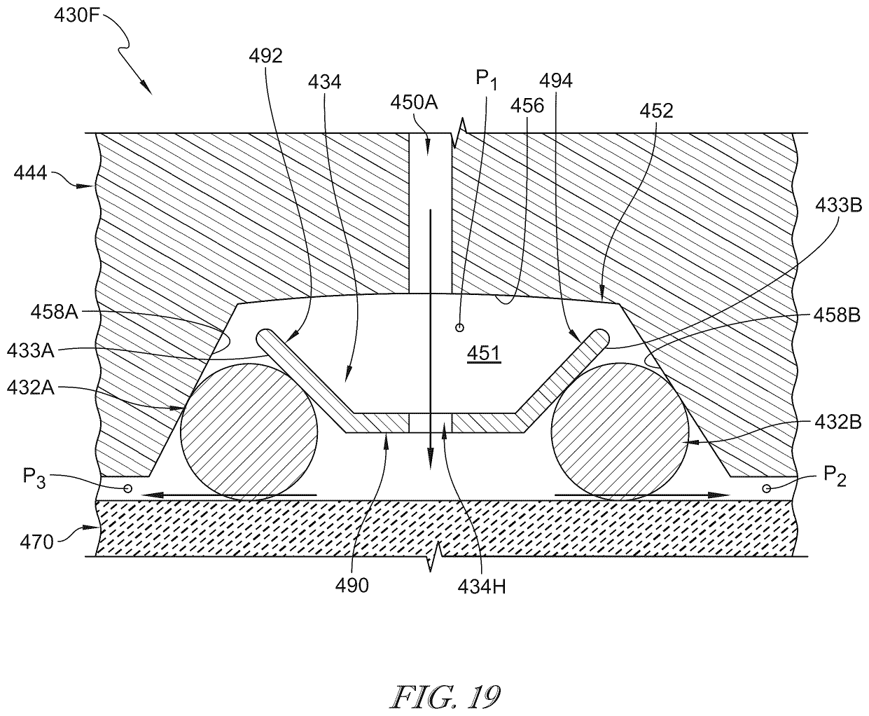

The sled member 434 has a trapezoidal cross-sectional shape or u-shape when viewed in the circumferential direction as shown in FIGS. 18 and 19. The u-shape of the sled member 434 defines a planar section 490, a first leg 492, and a second leg 494. The planar section 490 of the sled member 434 extends axially and circumferentially relative to the axis 11. Each of the legs 492, 494 extends axially and radially outward from the planar section 490.

In the illustrative embodiment, the shape of the sled member 434 creates a groove. The groove opens radially outward and faces towards the end surface 456 of the first channel 452.

The lips 492, 494 define angled surfaces 433A, 433B as shown in FIG. 19. The angled surfaces 433A, 433B of the sled member 434 engage the respective first and second seal members 432A, 432B. The first angled surface 433A engages the first seal member 432A and the second angled surface 433B engages the second seal member 432B.

The engagement of the angled surfaces 433A, 433B of the sled member 434 and the seal members 432A, 432B restricts the flow of air around the sled member 434. In this way, when the buffer air is discharged into the first channel 452, the buffer air pressurizes the space or buffer air cavity 451 created between the sled member 434 and the carrier segment 424. This causes the sled member 434 to urge engagement of the seal members 432A, 432B with the carrier segment 424 and the blade track segment 426.

The sled member 434 urges the first seal member 432A radially inward and axially forward into engagement with the shroud wall 470 of the blade track segment 426 and a first side surface 458A of the first channel 452 formed in the carrier segment 424. The sled member 434 urges the second seal member 432B radially inward and axially forward into engagement with the shroud wall 470 of the blade track segment 426 and the second side surface 458B of the first channel 52 formed in the carrier segment 424.

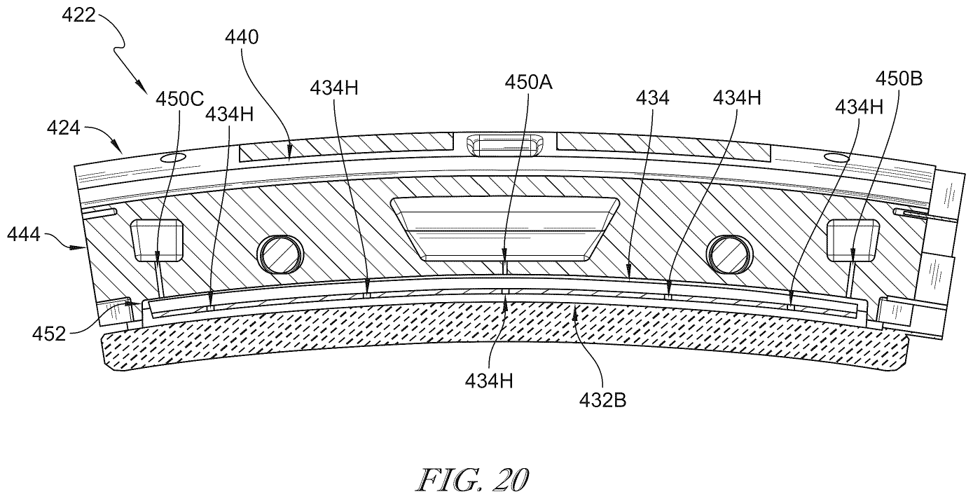

The sled member 434 extends between a first circumferential end 434A and a second circumferential end 434B spaced apart from the first circumferential end 434A as shown in FIGS. 17 and 20. In the illustrative embodiment, the sled member 434 is formed to include through holes 434H that extend radially through the sled member 434. The through holes 434H allow the buffer air to flow through the sled member 434 as suggested by arrow A in FIG. 19.

The carrier segment 424 includes an outer wall 440, a pair of hangers 442, the forward support wall 444, and the aft support wall 446 as shown in FIGS. 17-20. The outer wall 440 extends circumferentially at least partway about the axis 11. The hangers 442 extend radially outward from the outer wall 440. The forward support wall 444 and the aft support wall 446 each extend radially inward from the outer wall 440 on either side of the attachment flanges 474, 476.

The forward and aft support walls 444, 446 of the carrier segment 424 each include a corresponding channel 452, 454 as shown in FIGS. 14-16. The forward support wall 444 is formed to include the first channel 452 and the aft support wall 446 is formed to include the second channel 454.

In the illustrative embodiment, the first channel 452 is defined by an end surface 456, a first side surface 458A, and a second side surface 458B as shown in FIG. 19. The end surface 456 extends axially and faces radially-inwardly toward the blade track segment 426. The first side surface 458A extends radially inward and axially forward from the end surface 456. The second side surface 458B extends radially inward and axially aft from the end surface 456. The sled member 436 urges the first seal member 432A radially inward and axially forward into the first side surface 458A of the first channel 452 and urges the second seal member 432B radially inward and axially aft into the second side surface 458B of the first channel 452.

The forward support wall 444 is also formed to include buffer air passageways 450A, 450B, 450C as shown in FIGS. 18-20. Each buffer air passageway 450A, 450B, 450C extends into the forward support wall 444 and opens into the first channel 452.

A method of assembling and using the turbine shroud segment 422 may include several steps. The method includes arranging the seal assemblies 430F, 430A in the corresponding channels 452, 454 before arranging the blade track segment 426 adjacent to the carrier segment 424. The method includes arranging the forward seal assembly 430F in the first channel 452 and arranging the aft seal assembly 430A in the second channel 454.

The forward seal assembly 430F is arranged in the first channel 452 so that the sled member 434 is located radially outward of and axially between the first and second seal members 432A, 432B. Arranging the forward seal assembly 430F in the first channel 452 includes several steps. First, the sled member 434 is inserted or arranged in the first channel 452 so that the groove formed by the shape of the sled member 434 faces radially outward.

Next the first and second seal members 432A, 432B are arranged in the first channel 452 radially inward of the sled member 434. The first seal member 432A is arranged in the space defined between the angled surface 433A of the sled member 434 and the first side surface 458A of the channel 452. The second seal member 432B is arranged in the space defined between the angled surface 433B of the sled member 434 and the second side surface 458B of the channel 452. The order of arranging the first and second seal members 432A, 432B may be varied. In other words, either seal member 432A, 432B may be arranged in the first channel 452 before the other.

Once all the seal assemblies 430F, 430A are arranged in the corresponding channels 452, 454, the blade track segment 426 is arranged adjacent to the carrier segment 424 so that the seal assemblies 430F, 430A are radially between the carrier segment 424 and the shroud wall 470 of the blade track segment 426 to block gases in the gas path from flowing between the carrier segment 424 and the blade track segment 426. The method further includes biasing the sled member 434 radially inward to urge the first seal member 432A radially inward and axially forward and the second seal member 432B radially inward and axially aft into engagement with the carrier segment 424 and the shroud wall 470 of the blade track segment 426.

The method further includes discharging a flow of buffer air through the at least one buffer air passageway 450A, 50B, 50C. The method may further include discharging the flow of buffer air through the plurality of buffer air passageways 450A, 50B, 50C. The sled member 434 is biased radially inward by the buffer air discharged into the first channel 452.

The buffer air discharged into the buffer air cavity 451 establishes a higher pressure P₁ than the pressure P₂ in the region axially forward of the buffer air seal assembly 430F and the pressure P₃ in the cavity 448 as shown in FIG. 19. The buffer air in the buffer air cavity 451 is bled into the space or buffer air cavity defined between the seal members 432A, 432B and the sled member 434 as shown in FIG. 19 to establish a higher pressure axially between the seal members 432A, 432B than axially forward and aft of the seal members 432A, 432B. The pressure P₃ in the cavity 448 is lower than the pressure P₂ in the region axially forward of the buffer air seal assembly 430F radially outward of the gas path 25 as shown in FIG. 19. The buffer air may be provided from the compressor 14 of the gas turbine engine 10.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A turbine shroud assembly adapted for use with a gas turbine engine, the turbine shroud assembly comprising
a carrier segment arranged circumferentially at least partway around an axis, the carrier segment including an outer wall, a first support wall that extends radially inward from the outer wall, and a second support wall that extends radially inward from the outer wall at a location spaced apart axially from the first support wall to define an attachment-receiving space, and the first support wall formed to include a radially-inwardly opening first channel that extends circumferentially relative to the axis and at least one buffer air passageway that extends radially into the first support wall and opens into the first channel to discharge buffer air radially inward away from the carrier segment,
a blade track segment arranged circumferentially at least partway around the axis to define a portion of a gas path of the gas turbine engine, the blade track segment having a shroud wall that extends circumferentially partway around the axis and an attachment feature that extends radially outward from the shroud wall into the attachment-receiving space of the carrier segment, and
a buffer air seal assembly arranged in the first channel between the carrier segment and the blade track segment to block gases from flowing between the carrier segment and the blade track segment, the buffer air seal assembly including a first seal member that extends circumferentially relative to the axis, a second seal member spaced apart axially from the first seal member that extends circumferentially relative to the axis, a sled member located radially outward of and axially between the first and second seal members that extends circumferentially relative to the axis,
wherein the sled member is biased radially inward to urge the first seal member radially inward and axially forward and the second seal member radially inward and axially aft into engagement with the carrier segment and the blade track segment.

2. The turbine shroud assembly of claim 1, wherein the buffer air seal assembly further includes a bias member that extends circumferentially relative to the axis, and wherein the bias member is compressed radially between the carrier segment and the sled member to apply a bias force to the sled member to bias the sled member radially inward towards the shroud wall of the blade track segment.

3. The turbine shroud assembly of claim 2, wherein the bias member is a spring arranged radially between the carrier segment and the sled member to apply the bias force to the sled member.

4. The turbine shroud assembly of claim 3, wherein the spring has a first edge and a second edge spaced apart axially from the first edge, and wherein the first and second edges are scalloped to allow the buffer air to flow around the spring.

5. The turbine shroud assembly of claim 2, wherein the bias member is a braid seal that extends circumferentially about the axis.

6. The turbine shroud assembly of claim 5, wherein the bias member is segmented into a first segment and a second segment spaced apart circumferentially from the first segment, and wherein the at least one buffer air passageway is located circumferentially between the first and second segments of the bias member.

7. The turbine shroud assembly of claim 2, wherein the bias member is formed to include at least one through hole that extends radially therethrough to allow the buffer air to flow through the bias member.

8. The turbine shroud assembly of claim 1, wherein the buffer air discharged into the first channel biases the sled member radially inward toward the blade track segment.

9. The turbine shroud assembly of claim 1, wherein the sled has one of a semi-circle cross-sectional shape, a triangular cross-sectional shape, and a trapezoidal cross-sectional shape when viewed in a circumferential direction.

10. The turbine shroud assembly of claim 1, wherein the sled member is formed to include at least one through hole that extends radially therethrough to allow the buffer air to flow through the sled member.

11. The turbine shroud assembly of claim 1, wherein the first seal member and the second seal member each comprise a single strand of solid metallic material.

12. The turbine shroud assembly of claim 1, wherein the first channel is formed to define an end surface that extends axially, a first side surface that extends radially inward and axially forward from the end surface, and a second side surface that extends radially inward and axially aft from the end surface, wherein the sled member urges the first seal member radially inward and axially forward into the first side surface of the first channel, and wherein the sled member urges the second seal member radially inward and axially aft into the second side surface of the first channel.

13. The turbine shroud assembly of claim 1, wherein the second support wall is formed to include a radially-inwardly opening second channel that extends circumferentially relative to the axis, and the turbine shroud assembly further comprises another seal arranged in the second channel.

14. The turbine shroud assembly of claim 1, further comprising at least one retainer that extends axially into the carrier segment and through the attachment feature of the blade track segment so as to couple the blade track segment to the carrier segment.

15. A method comprising:
providing a carrier segment arranged circumferentially at least partway around an axis, the carrier segment formed to include a radially-inwardly opening first channel and at least one buffer air passageway that extends radially into the carrier segment and opens into the first channel,
providing a blade track segment arranged circumferentially at least partway around the axis, the blade track segment having a shroud wall that extends circumferentially partway around the axis and an attachment feature that extends radially outward from the shroud wall,
providing a buffer air seal assembly including a first seal member, a second seal member, and a sled member that each extend circumferentially relative to the axis,
arranging the buffer air seal assembly in the radially-inwardly opening first channel formed in the carrier segment so that the sled member is located radially outward of and axially between the first and second seal members,
arranging the blade track segment adjacent to the carrier segment so that the buffer air seal assembly is radially between the carrier segment and the shroud wall of the blade track segment to block gases in from flowing between the carrier segment and the blade track segment,
biasing the sled member radially inward to urge the first seal member radially inward and axially forward and the second seal member radially inward and axially aft into engagement with the carrier segment and the shroud wall of the blade track segment, and
discharging a flow of buffer air through the at least one buffer air passageway into the first channel.

16. The method of claim 15, wherein the sled has one of a semi-circle cross-sectional shape, a triangular cross-sectional shape, and a trapezoidal cross-sectional shape when viewed in a circumferential direction.

17. The method of claim 15, wherein the sled member is formed to include at least one through hole that extends radially therethrough to allow the flow of buffer air to flow through the sled member.

18. The method of claim 15, wherein the first seal member and the second seal member each comprise a single strand of solid metallic material.

19. The method of claim 15, wherein the first channel is formed to define an end surface that extends axially, a first side surface that extends radially inward and axially forward from the end surface, and a second side surface that extends radially inward and axially aft from the end surface, and wherein the sled member urges the first seal member radially inward and axially forward into the first side surface of the first channel and urges the second seal member radially inward and axially aft into the second side surface of the first channel.

20. The method of claim 15, further comprising providing at least one retainer and inserting the at least one retainer axially into the carrier segment and through the attachment feature of the blade track segment to couple the blade track segment to the carrier segment.
